(19) United States
(12) Patent Application Publication
(10) Pub. No.: US 2026/0106369 A1
(43) Pub. Date: Apr. 16, 2026

(54) ANTENNA DEVICE AND ELECTRONIC DEVICE INCLUDING THE SAME

(71) Applicant: Samsung Electronics Co., Ltd., Suwon-si (KR)

(72) Inventors: Doohyun YANG, Suwon-si (KR); Woncheol LEE, Suwon-si (KR); Youngki LEE, Suwon-si (KR); Hyung Sun LIM, Suwon-si (KR)

(73) Assignee: Samsung Electronics Co., Ltd., Suwon-si (KR)

(21) Appl. No.: 19/284,131

(22) Filed: Jul. 29, 2025

(30) Foreign Application Priority Data
Oct. 14, 2024 (KR) 10-2024-0139269

(51) Int. Cl. H01Q 1/52; H01Q 5/30

(52) U.S. Cl. CPC H01Q 1/523; H01Q 1/526; H01Q 5/30

(57) ABSTRACT

Disclosed are an antenna device and an electronic device including the same. The antenna device includes a printed circuit board, a first antenna on a first surface of the printed circuit board, the first antenna including a first sensing antenna and a second sensing antenna, a second antenna on the first surface, the second antenna including a plurality of antenna elements, a first sensing shield structure forming a first groove, the first sensing antenna being within the first groove, and processing circuitry electrically connected to the first antenna and the second antenna, the processing circuitry being configured to transmit a first signal of a first frequency band by supplying power to the first sensing antenna and the second sensing antenna, and transmit a second signal of a second frequency band by supplying power to the plurality of antenna elements, the second frequency band being different from the first frequency band.

### CROSS-REFERENCE TO RELATED APPLICATIONS

This application claims priority under 35 U.S.C. § 119 to Korean Patent Application No. 10-2024-0139269 filed on Oct. 14, 2024, in the Korean Intellectual Property Office, the disclosure of which is incorporated by reference herein in its entirety.

### BACKGROUND

Embodiments of the present disclosure described herein relate to an antenna device and an electronic device including the same.

As mobile communication technology advances, electronic devices equipped with antennas have been widespread. An electronic device may use an antenna to transmit and/or receive a radio frequency (RF) signal including a voice signal or data (e.g., a message, a picture, a video, a music file, or a game).

An electronic device may transmit and/or receive signals belonging to different frequency bands by using multiple antennas. For example, an electronic device may perform communication using a signal having a relatively low frequency band (e.g., 28 GHz) and communication using a signal having a relatively high frequency band (e.g., 60 GHz).

In addition, as the demand for miniaturization of electronic devices increases, multiple antennas may be formed on a single substrate to minimize (or reduce) the physical dimensions (e.g., area) of an electronic device.

### SUMMARY

Embodiments of the present disclosure provide an antenna device that reduces interference between antennas that are formed on a single substrate and transmit and/or receive signals of different frequency bands.

According to embodiments, an antenna device includes a printed circuit board, a first antenna on a first surface of the printed circuit board, the first antenna including a first sensing antenna and a second sensing antenna, a second antenna on the first surface, the second antenna including a plurality of antenna elements, a first sensing shield structure forming a first groove, the first sensing antenna being within the first groove, and processing circuitry electrically connected to the first antenna and the second antenna, the processing circuitry being configured to transmit a first signal of a first frequency band by supplying power to the first sensing antenna and the second sensing antenna, and transmit a second signal of a second frequency band by supplying power to the plurality of antenna elements, the second frequency band being different from the first frequency band.

According to embodiments, an antenna device includes a printed circuit board, a first antenna on a first surface of the printed circuit board, the first antenna including a first sensing antenna and a second sensing antenna, a second antenna on the first surface, the second antenna including a plurality of antenna elements, and the second antenna being between the first sensing antenna and the second sensing antenna, a first sensing shield structure forming a first groove, the first sensing antenna being within the first groove, and the first sensing shield structure forming an opening in the first surface, and processing circuitry electrically connected to the first antenna and the second antenna, the processing circuitry being configured to transmit signals of different frequency bands by supplying power to each of the first antenna and the second antenna.

According to embodiments, an antenna device includes a printed circuit board, a first antenna on a first surface of the printed circuit board, the first antenna including a first sensing antenna and a second sensing antenna, a second antenna on the first surface, the second antenna including a plurality of antenna elements, and the plurality of antenna elements being between the first sensing antenna and the second sensing antenna, a first sensing shield structure forming a first groove, the first sensing antenna being in the first groove, and the first sensing shield structure forming an opening in the first surface, a radio frequency front end (RFFE) connected to the first antenna and the second antenna, a radio frequency integrated circuit (RFIC) connected to the RFFE, and processing circuitry electrically connected to the first antenna and the second antenna through the RFIC and the RFFE, the processing circuitry being configured to transmit signals of different frequency bands by supplying power to each of the first antenna and the second antenna.

According to embodiments, a method of controlling transmission power of an antenna device includes transmitting a first signal through a first antenna, determining whether an external object is positioned within a first distance from the antenna device based on the transmitting, and transmitting a second signal through a second antenna at a first transmission power in response to determining the external object is positioned within the first distance from the antenna device, a first frequency of the first signal being different from a second frequency of the second signal, the first antenna and the second antenna being on a common printed circuit board in the antenna device, and the printed circuit board including a shield structure between the first antenna and the second antenna.

According to embodiments, the first antenna includes a first sensing antenna and a second sensing antenna, the transmitting includes transmitting the first signal through the first sensing antenna, and the method further includes receiving a reflected signal through the second sensing antenna, the reflected signal corresponding to the first signal transmitted from the first sensing antenna reflected by the external object.

According to embodiments, the determining includes obtaining distance information between the antenna device and the external object based on the reflected signal and determining whether the external object is positioned within the first distance from the antenna device based on the distance information.

According to embodiments, the first transmission power is less than or equal to a first maximum power set for the first distance.

According to embodiments, a wireless communication device includes a first antenna on a first surface of a printed circuit board, the first antenna including a first sensing antenna and a second sensing antenna, a second antenna on the first surface, the second antenna including a plurality of antenna elements, and the plurality of antenna elements being between the first sensing antenna and the second sensing antenna, a first sensing shield structure forming a first groove, the first sensing antenna being in the first groove, and the first sensing shield structure forming an opening in the first surface, a radio frequency integrated circuit (RFIC) connected to the first antenna and the second antenna, a power modulator connected to the first antenna and the second antenna, and a communication processor configured to control the RFIC and the power modulator to cause the first antenna and the second antenna to transmit signals of different frequency bands.

According to embodiments, an Internet of Things (IoT) device includes a communication interface and a processor, the communications interface including a first antenna on a first surface of a printed circuit board, the first antenna including a first sensing antenna and a second sensing antenna, a second antenna on the first surface, the second antenna including a plurality of antenna elements, and the plurality of antenna elements being between the first sensing antenna and the second sensing antenna, a first sensing shield structure forming a first groove, the first sensing antenna being in the first groove, and the first sensing shield structure forming an opening in the first surface, the processor is configured to transmit signals of different frequency bands by supplying power to each of the first antenna and the second antenna.

According to embodiments, mobile terminal includes a Radio Frequency (RF) module and a processor, the RF module including a first antenna on a first surface of a printed circuit board, the first antenna including a first sensing antenna and a second sensing antenna, a second antenna on the first surface, the second antenna including a plurality of antenna elements, and the plurality of antenna elements being between the first sensing antenna and the second sensing antenna, a first sensing shield structure forming a first groove, the first sensing antenna being in the first groove, and the first sensing shield structure forming an opening in the first surface, the processor is configured to transmit signals of different frequency bands by supplying power to each of the first antenna and the second antenna.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an antenna device according to embodiments of the present disclosure.

FIG. 2 is a perspective view of an antenna device according to embodiments viewed from one side.

FIG. 3A is a plan view illustrating the antenna device of FIG. 2.

FIG. 3B is a perspective view of the antenna device of FIG. 2 viewed from another side.

FIG. 3C is a cross-sectional view of the antenna device of FIG. 2 taken along line A-A′.

FIG. 4A is a perspective view of part B of FIG. 3C.

FIG. 4B is a cross-sectional view of part B of FIG. 4A taken along line C-C′.

FIG. 5 is a cross-sectional view of an antenna device according to embodiments.

FIG. 6 is a plan view illustrating the antenna device of FIG. 5.

FIG. 7 is a perspective view of an antenna device according to embodiments.

FIG. 8 is a cross-sectional view of the antenna device of FIG. 7 taken along line D-D.′

FIG. 9 is a perspective view of an antenna device for detecting an external object according to embodiments.

FIG. 10 is a flowchart illustrating a method of controlling transmission power of an antenna device based on distance information between an external object and the antenna device according to embodiments.

FIG. 11 is a block diagram illustrating an antenna device according to embodiments.

FIG. 12 is a block diagram illustrating an electronic device according to embodiments.

FIG. 13 is a block diagram illustrating an IoT device including an electronic device according to embodiments.

FIG. 14 is a block diagram illustrating a mobile terminal to which an electronic device according to embodiments is applied.

### DETAILED DESCRIPTION

Hereinafter, embodiments of the present disclosure will be described clearly and in detail so that those skilled in the art may easily carry out embodiments of the present disclosure.

The terms, such as “first”, “second”, and the like used herein may refer to various elements of embodiments of the present disclosure regardless of the order or importance, and are only used to distinguish one element from another, but do not limit the order or importance of the elements.

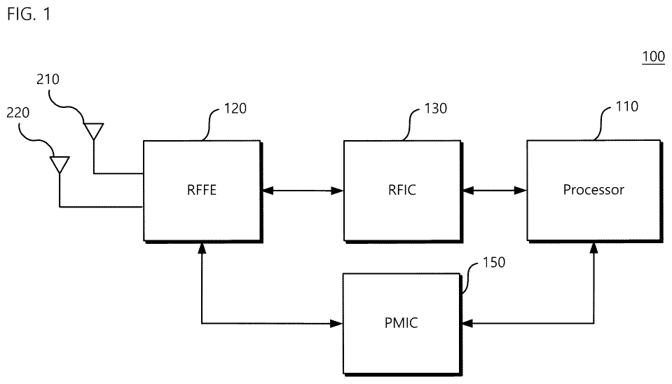

FIG. 1 is a block diagram illustrating an antenna device according to embodiments of the present disclosure.

Referring to FIG. 1, an antenna device 100 according to embodiments may include a first antenna 210, a second antenna 220, a radio frequency front end (RFFE) 120, a radio frequency integrated circuit (RFIC) 130, a power management integrated circuit (PMIC) 150, and/or a processor 110.

The antenna device 100 may include the first antenna 210 and the second antenna 220 that transmit and/or receive signals of different frequency bands.

In more detail, the antenna device 100 may include the first antenna 210 that transmits and receives a first signal of a first frequency band. In addition, the antenna device 100 may include the second antenna 220 that transmits a second signal of a second frequency band.

Therefore, the antenna device 100 of the present disclosure may be referred to as an antenna module or a wireless communication device including the first antenna 210 and the second antenna 220.

According to embodiments, the first signal may be referred as a radar signal for obtaining location information of an external object adjacent to the antenna device 100. For example, the first signal may be referred as a radar signal having a frequency band of about 60 GHz.

In addition, the second signal may be referred to as a radio frequency (RF) signal for wireless communication in a specified frequency band.

For example, the second signal may be referenced as an mmWave signal having a frequency band of about 28 GHz. As another example, the second signal may be referred to as a long-term evolution (LTE) signal having a frequency band of about 700 MHz

However, the type and frequency band of each of the first and second signals are not limited to the examples described above.

According to embodiments, the first antenna 210 and the second antenna 220 may be formed on a single printed circuit board. In addition, the first antenna 210 and the second antenna 220 may both be electrically connected to the single RFFE 120 and the single RFIC 130 (e.g., both of the first antenna 210 and the second antenna 220 may be connected to the only single RFFE 120 and the only single RFIC 130).

That is, the antenna device 100 may transmit and receive signals of different frequency bands by using the first antenna 210 and the second antenna 220 formed on a single printed circuit board.

The antenna device 100 may include the RFFE 120 that receives an RF signal through the first antenna 210 and/or the second antenna 220.

According to embodiments, the RFFE 120 may perform pre-processing (or processing) on a signal received through the first antenna 210 and/or the second antenna 220.

For example, the RFFE 120 may preprocess (or process) an RF signal received through the second antenna 220.

To this end, the RFFE 120 may include at least some of a phase shifter, a band pass filter, and/or a switching circuit connected to the first antenna 210 and the second antenna 220.

The antenna device 100 may include the RFIC 130 connected to the RFFE 120. In more detail, the antenna device 100 may include the RFIC 130 that converts a baseband signal into an RF signal or converts an RF signal into a baseband signal.

For example, upon reception, the RFIC 130 may convert an RF signal preprocessed (or processed) through the RFFE 120 into a baseband signal such that the processor 110 processes the baseband signal.

In addition, for example, the RFIC 130 may convert a baseband signal generated by the processor 110 into an RF signal of the Sub6 band (about 6 GHz or less) used for a first network (e.g., a 5G network) during transmission.

For another example, the RFIC 130 may convert the baseband signal generated by the processor 110 into an RF signal of the 5G Above5 band (e.g., about 6 GHz to about 60 GHz) used for a second network (e.g., a 5G network) during transmission.

As still another example, during transmission, the RFIC 130 may convert the baseband signal generated by the processor 110 into an RF signal of about 700 MHz to about 3 GHz used in a third network (e.g., a legacy network).

The antenna device 100 may include the processor 110 electrically connected to the RFIC 130 and/or the PMIC 150.

For example, the processor 110 may control at least one other component (e.g., the RFIC 130 or the PMIC 150) of the antenna device 100 by executing software (or a program), and may perform various data processing or operations. The processor 110 may include a central processor or a microprocessor, and may control the overall operation of the antenna device 100. Accordingly, it may be understood that the operation performed by the antenna device 100 below is performed under the control of the processor 110.

According to embodiments, the processor 110 may include an algorithm for controlling at least a portion of the RFIC 130 or the PMIC 150. For example, the algorithm may include software code programmed inside the processor 110. For another example, the algorithm may include hard code hard-coded within the processor 110, but embodiments are not limited thereto.

The processor 110 may control the RFIC 130 and the PMIC 150 according to an algorithm to provide transmission power to each of the first antenna 210 and the second antenna 220.

The PMIC 150 may supply power to the first antenna 210 and the second antenna 220 under the control of the processor 110. In more detail, the PMIC 150 may provide transmission power to the first antenna 210 and the second antenna 220 through the RFFE 120 under the control of the processor 110.

For example, the PMIC 150 may provide transmission power for transmitting a first signal to the first antenna 210 under the control of the processor 110. In addition, the PMIC 150 may provide transmission power for transmitting a second signal to the second antenna 220 under the control of the processor 110.

Accordingly, the processor 110 may transmit and/or receive signals of specified frequency bands, respectively, by using the first antenna 210 and/or the second antenna 220.

Therefore, the processor 110 according to embodiments of the present disclosure may be referred to as a communication processor (CP).

According to embodiments, the processor 110 may obtain distance information between an external object and the antenna device 100 through the first antenna 210.

For example, the processor 110 may measure the distance between an external object adjacent to the antenna device 100 and the antenna device 100 by transmitting and receiving a radar signal through the first antenna 210.

Furthermore, the processor 110 may control the transmission power for the second antenna 220 based on the obtained distance information.

In more detail, when an external object exists within a preset (or alternatively, given) distance from the antenna device 100, the processor 110 may provide transmission power less than or equal to the maximum (or highest) power set according to the distance to the second antenna 220.

In this case, for example, the maximum (or highest) power set according to the distance may be set to meet specifications for at least some of a specific absorption rate (SAR), power density (PD) and/or total exposure ratio (TER).

Referring to the above-described configurations, the antenna device 100 may include the first antenna 210 and the second antenna 220 that transmit and receive signals of different frequency bands. In this case, the first antenna 210 and the second antenna 220 may be implemented on a single printed circuit board.

Therefore, the antenna device 100 according to embodiments of the present disclosure may have a relatively small area (e.g., relatively small physical dimensions) compared to the case where the antennas 210 and 220 for transmitting and receiving signals of different frequency bands are arranged on separate printed circuit boards.

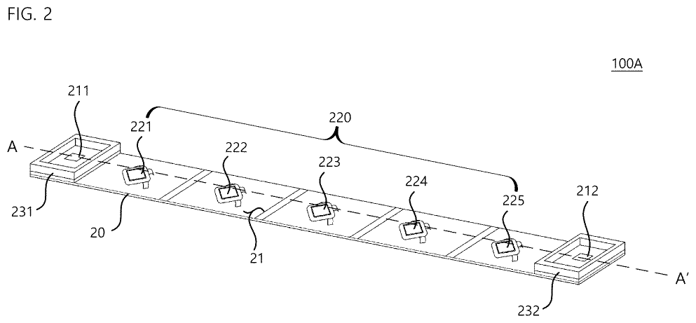

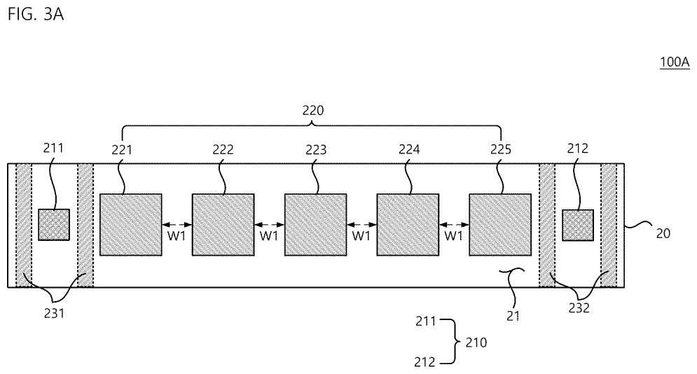

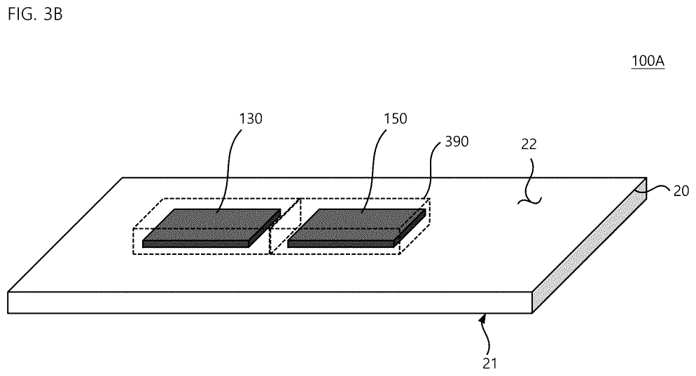

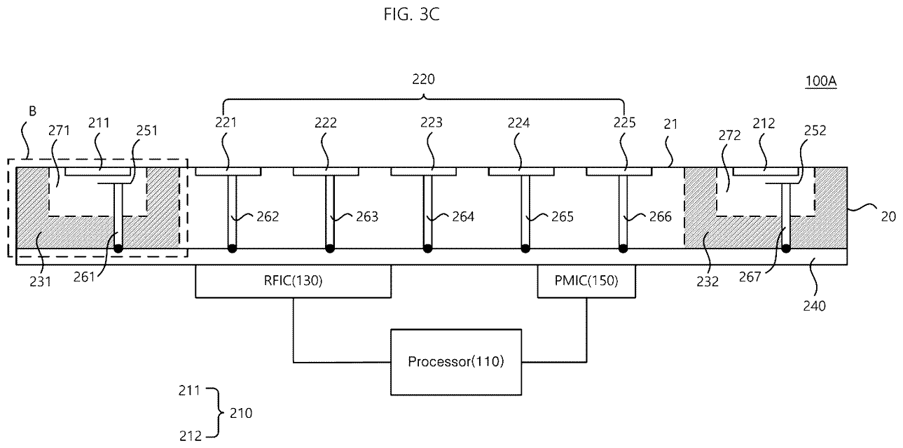

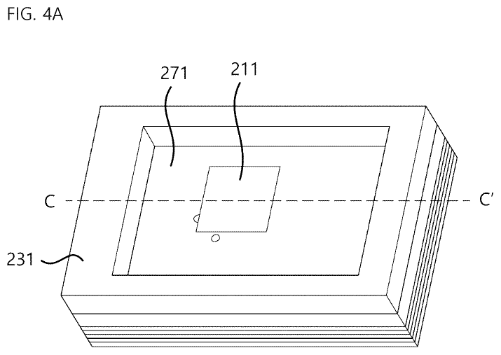

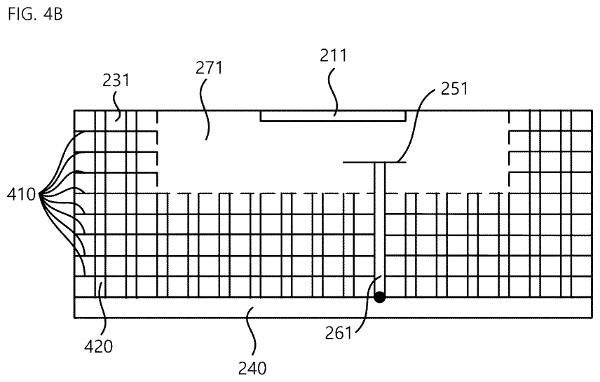

FIG. 2 is a perspective view of an antenna device according to embodiments viewed from one side. FIG. 3A is a plan view illustrating the antenna device of FIG. 2. FIG. 3B is a perspective view of the antenna device of FIG. 2 viewed from another side. FIG. 3C is a cross-sectional view of the antenna device of FIG. 2 taken along line A-A′. FIG. 4A is a perspective view of part B of FIG. 3C. FIG. 4B is a cross-sectional view of part B of FIG. 4A taken along line C-C′.

Referring to FIG. 2 and FIGS. 3A to 3C together, an antenna device 100A according to embodiments may include a printed circuit board 20, the first antenna 210, the second antenna 220, the RFIC 130, the processor 110, and/or the PMIC 150. However, according to embodiments, at least some of the above-described configurations may be omitted, or at least two of the above-described configurations may be formed integrally. In addition, the antenna device 100A according to embodiments may further include a shield member 390.

In this case, the antenna device 100A illustrated in FIG. 2 and FIGS. 3A to 3C may be understood as an example of the antenna device 100 illustrated in FIG. 1. Therefore, the same reference numerals (or similar reference numerals) will be used for components that are identical or substantially identical to the components described above, and duplicate descriptions of the same components (or similar components) will be omitted.

According to embodiments, the printed circuit board 20 may include a plurality of conductive layers and a plurality of non-conductive layers laminated alternately with the plurality of conductive layers.

The printed circuit board 20 may provide electrical connections between the printed circuit board 20 and/or various electronic components arranged at an outside thereof (e.g., externally thereto) by using wires and conductive vias formed in the conductive layer.

Referring to FIG. 2, the first antenna 210 may include a first sensing antenna 211 and a second sensing antenna 212.

In more detail, the first antenna 210 may include the first sensing antenna 211 that transmits a first signal. In addition, the first antenna 210 may include the second sensing antenna 212 that receives the first signal.

According to embodiments, the first sensing antenna 211 and the second sensing antenna 212 may be arranged on a first surface 21 of the printed circuit board 20.

In more detail, the first sensing antenna 211 and the second sensing antenna 212 may be arranged to allow at least a portion of each surface thereof to be in contact with an outside of the printed circuit board 20 through the first surface 21 of the printed circuit board 20 (e.g., at least a portion of each surface thereof is not covered by the first surface 21).

In addition, the first sensing antenna 211 and the second sensing antenna 212 may be arranged spaced apart from each other on the first surface 21 of the printed circuit board 20.

Referring to FIGS. 2 and 3A together, the second antenna 220 may include a plurality of antenna elements 221, 222, 223, 224, and/or 225 (e.g., a first antenna element 221, a second antenna element 222, a third antenna element 223, a fourth antenna element 224 and/or a fifth antenna element 225) arranged to form a directional beam.

In this case, for example, the second antenna 220 may include the plurality of antenna elements 221, 222, 223, 224, and 225 arranged in an array of 1×5.

The plurality of antenna elements 221, 222, 223, 224, and 225 may be formed on the first surface 21 of the printed circuit board 20.

In more detail, each of the plurality of antenna elements 221, 222, 223, 224, and 225 may be arranged such that at least a portion of the surface thereof is in contact with the outside of the printed circuit board 20 through the first surface 21 of the printed circuit board 20 (e.g., at least a portion of each surface thereof is not covered by the first surface 21).

Referring to FIG. 3A, the plurality of antenna elements 221, 222, 223, 224, and 225 may be arranged between the first sensing antenna 211 and the second sensing antenna 212 on the first surface 21.

In more detail, the plurality of antenna elements 221, 222, 223, 224, and 225 may be arranged (e.g., spaced apart) in an array of 1×5 at a constant interval W1 (e.g., a constant distance interval W1) between the first sensing antenna 211 and the second sensing antenna 212.

Therefore, for example, the first sensing antenna 211, the second sensing antenna 212 and the plurality of antenna elements 221, 222, 223, 224, and 225 may be arranged in an array of 1×7 on the first surface 21.

However, the number and arrangement of antenna elements included in the first antenna 210 and/or the second antenna 220 are not limited to the examples described above.

Referring to the above-described configurations, the first sensing antenna 211 and the second sensing antenna 212 may be arranged to be spaced apart from each other on the first surface 21 while interposing the plurality of antenna elements 221, 222, 223, 224, and 225 therebetween.

Therefore, while the processor 110 transmits the first signal through the first sensing antenna 211 and receives the first signal through the second sensing antenna 212, the return current flowing from the first sensing antenna 211 to the second sensing antenna 212 may be minimized (or reduced).

That is, the antenna device 100A may improve the isolation between the first sensing antenna 211 and the second sensing antenna 212. Thus, the antenna device 100A according to embodiments of the present disclosure may improve the performance of the first antenna 210.

According to embodiments, at least one of the first sensing antenna 211 and/or the second sensing antenna 212 may be arranged between the plurality of antenna elements 221, 222, 223, 224, and 225.

For example, the first sensing antenna 211 may be arranged between the first antenna element 221 and the second antenna element 222, and the second sensing antenna 212 may be arranged between the fourth antenna element 224 and the fifth antenna element 225.

For another example, the first sensing antenna 211 may be arranged between the second antenna element 222 and the third antenna element 223, and the second sensing antenna 212 may be arranged between the third antenna element 223 and the fourth antenna element 224.

However, the arrangement of each of the first sensing antenna 211, the second sensing antenna 212, and the plurality of antenna elements 221, 222, 223, 224, and 225 is not limited to the examples described above.

In addition, the second antenna 220 according to embodiments may include a plurality of antenna arrays of various types (e.g., a dipole antenna array, and/or a patch antenna array).

Referring to FIG. 3B, the RFIC 130 may be arranged on a second surface 22 of the printed circuit board 20. In more detail, the RFIC 130 may be arranged on the second surface 22 that is parallel to the first surface 21 of the printed circuit board 20.

According to embodiments, the RFIC 130 may convert a baseband signal obtained from the processor 110 into an RF signal of a specified band during transmission. In addition, during receiving, the RFIC 130 may convert an RF signal received through the second antenna 220 into a baseband signal and transmit the baseband signal to the processor 110.

According to embodiments, the RFIC 130 may up-convert an IF signal (e.g., about 9 GHz to about 11 GHz) obtained from an intermediate frequency integrated circuit (IFIC) to an RF signal of a selected band during transmission. During receiving, the RFIC 130 may down-convert an RF signal obtained through the second antenna 220 into an IF signal and transmit the IF signal to the IFIC.

In addition, the PMIC 150 may be arranged on the second surface 22 of the printed circuit board 20. The PMIC 150 may receive a voltage (e.g., a control signal) from the processor 110 (or power source) and provide power required (or otherwise, used) for the configuration of the antenna device 100A (e.g., the RFIC 130, the first antenna 210, or the second antenna 220).

The shield member 390 may be arranged on a portion (e.g., the second surface 22) of the printed circuit board 20 to electromagnetically shield at least one of the RFIC 130 or the PMIC 150. In this case, for example, the shield member 390 may be understood as a shield that may be arranged to surround at least a portion of the RFIC 130 and/or the PMIC 150.

Referring to FIG. 2, FIG. 3A and FIG. 3C together, the antenna device 100A according to embodiments may include a first sensing shield structure 231 and/or a second sensing shield structure 232.

In more detail, the antenna device 100A may include the first sensing shield structure 231 formed with a first groove 271 in which the first sensing antenna 211 is arranged.

The first sensing shield structure 231 may have a shape forming the first groove 271 that is opened through the first surface 21 (e.g., that forms an opening in the first surface 21). The first sensing shield structure 231 may have a shape surrounding the first groove 271.

In addition, the first sensing antenna 211 may be arranged within the first groove 271.

In more detail, the first sensing antenna 211 may be arranged within the first groove 271 such that at least one surface is in contact with the outside of the printed circuit board 20 through the first surface 21 (e.g., is not covered by the first surface 21).

In this case, for example, the space excluding a space of the first groove 271 where the first sensing antenna 211 is arranged may include a dielectric material. That is, the first sensing antenna 211 may be arranged to be surrounded by a dielectric material. According to embodiments, the first sensing shield structure 231 may include the dielectric material.

For another example, the first sensing antenna 211 may be arranged on the first surface 21 of the printed circuit board 20.

Referring to FIGS. 3A and 3C together, at least a portion of the first sensing shield structure 231 may be arranged between the first sensing antenna 211 and the first antenna element 221.

In more detail, at least a portion of the first sensing shield structure 231 may form a portion of the first surface 21 (e.g., may be level with the first surface 21) of the printed circuit board 20. In addition, a portion of the first sensing shield structure 231 forming the first surface 21 may be arranged between the first sensing antenna 211 and the first antenna element 221 on the first surface 21.

That is, at least a portion of the first sensing shield structure 231 may be formed between the first sensing antenna 211 and the first antenna element 221 on the first surface 21.

Accordingly, the first sensing shield structure 231 according to embodiments may reduce electrical interference between the first sensing antenna 211 formed through the first surface 21 and the first antenna element 221 (or, the second antenna 220).

In addition, the antenna device 100A may include the second sensing shield structure 232 forming a second groove 272 in which the second sensing antenna 212 is arranged.

The second sensing shield structure 232 may have a shape forming the second groove 272 that is opened through the first surface 21 (e.g., that forms an opening in the first surface 21). The second sensing shield structure 232 may have a shape surrounding the second groove 272.

In addition, the second sensing antenna 212 may be arranged within the second groove 272. In more detail, the second sensing antenna 212 may be arranged within the second groove 272 such that at least one surface thereof is in contact with the outside of the printed circuit board 20 through the first surface 21 (e.g., not covered by the first surface 21).

In this case, for example, the space excluding the space of the second groove 272 where the second sensing antenna 212 is arranged may include a dielectric material. That is, the second sensing antenna 212 may be arranged to be surrounded by a dielectric material. According to embodiments, the second sensing shield structure 232 may include the dielectric material.

For another example, the second sensing antenna 212 may be arranged on the first surface 21 of the printed circuit board 20.

In this case, for example, each of the first groove 271 and the second groove 272 may be referred to as a cavity formed in the printed circuit board 20.

Referring to FIGS. 3A and 3C together, at least a portion of the second sensing shield structure 232 may be arranged between the second sensing antenna 212 and the fifth antenna element 225.

In more detail, at least a portion of the second sensing shield structure 232 may form a portion of the first surface 21 of the printed circuit board 20. In addition, a portion of the second sensing shield structure 232 forming the first surface 21 may be arranged between the second sensing antenna 212 and the fifth antenna element 225 on the first surface 21.

That is, at least a portion of the second sensing shield structure 232 may be formed between the second sensing antenna 212 and the fifth antenna element 225 on the first surface 21.

Referring to the above-described configurations, the second sensing shield structure 232 according to embodiments may reduce electrical interference between the second sensing antenna 212 formed through the first surface 21 and the fifth antenna element 225 (or, the second antenna 220).

Through the above-described configurations, the antenna device 100A according to embodiments of the present disclosure may reduce performance degradation due to electrical interference between the first antenna 210 and the second antenna 220. For example, the antenna device 100A may reduce distortion of the radiation pattern of an RF signal transmitted through the first antenna 210 and the second antenna 220.

That is, the antenna device 100A may improve the radiation performance of the first antenna 210 and the second antenna 220 through the above-described configurations.

In addition, referring to FIG. 3C, the antenna device 100A according to embodiments may include a first coupling element 251 arranged within the first groove 271.

In more detail, the antenna device 100A may include the first coupling element 251 arranged to be spaced apart from the first sensing antenna 211 within the first groove 271.

In this case, for example, the first coupling element 251 may be arranged to be spaced apart from the first sensing antenna 211 by a specified distance or less.

The first coupling element 251 may be connected to a first power feeding path 261 penetrating the first sensing shield structure 231.

Therefore, the processor 110 according to embodiments may supply power to the first coupling element 251 through the first power feeding path 261. In this case, coupling may occur between the first coupling element 251 and the first sensing antenna 211.

That is, the processor 110 may supply power to the first sensing antenna 211 through coupling power feeding by supplying power to the first coupling element 251 through the first power feeding path 261.

The processor 110 may transmit a first signal of a specified frequency band (e.g., 60 GHz) through the first sensing antenna 211 by supplying power to the first sensing antenna 211 through coupling power feeding.

In addition, the antenna device 100A may include a second coupling element 252 arranged within the second groove 272.

In more detail, the antenna device 100A may include the second coupling element 252 arranged spaced apart from the second sensing antenna 212 within the second groove 272.

In this case, for example, the second coupling element 252 may be arranged to be spaced apart from the second sensing antenna 212 by a specified distance or less.

The second coupling element 252 may be connected to a seventh power feeding path 267 penetrating the second sensing shield structure 232.

Therefore, the processor 110 according to embodiments may supply power to the second coupling element 252 through the seventh power feeding path 267. In this case, coupling may occur between the second coupling element 252 and the second sensing antenna 212.

That is, the processor 110 may supply power to the second sensing antenna 212 through the seventh power feeding path 267, thereby supplying power to the second coupling element 252 through coupling power feeding.

However, referring to the above description, although it is described that the processor 110 supplies power to the first sensing antenna 211 and the second sensing antenna 212 through coupling power feeding, the scheme for supplying power to each of the first sensing antenna 211 and the second sensing antenna 212 is not limited thereto.

For another example, the first sensing antenna 211 may be connected (e.g., directly connected) to the first power feeding path 261, and the processor 110 may directly supply power to the first sensing antenna 211 through the first power feeding path 261.

In addition, the processor 110 may supply power to the plurality of antenna elements 221, 222, 223, 224, and 225 through power feeding paths 262, 263, 264, 265, and 266 (e.g., a second power feeding path 262, a third power feeding path 263, a fourth power feeding path 264, a fifth power feeding path 265 and a sixth power feeding path 266) connected to the plurality of antenna elements 221, 222, 223, 224, and 225, respectively.

For example, the processor 110 may supply power to the first antenna element 221 through the second power feeding path 262 connected to the first antenna element 221. In this case, the second power feeding path 262 may be formed to penetrate at least a portion of the printed circuit board 20.

Thus, the processor 110 may transmit a second signal having a specified frequency (e.g., 28 GHz) through the second antenna 220.

In this case, for example, the processor 110 may transmit a signal having a constant phase difference to the plurality of antenna elements 221, 222, 223, 224, and 225. Thus, the processor 110 may output a directional beam directed in a specified direction through the second antenna 220.

In addition, in this case, each of the first power feeding path 261 to the seventh power feeding path 267 may be implemented with at least one via.

In addition, the antenna device 100A (or the printed circuit board 20) may include a ground plane 240.

According to embodiments, the ground plane 240 may be formed in one of a plurality of layers within the printed circuit board 20. In this case, for example, the ground plane 240 may be electrically separated from the plurality of power feeding paths 261, 262, 263, 264, 265, 266, and 267.

Referring to FIGS. 3C, 4A and 4B together, the first sensing shield structure 231 according to embodiments may include a plurality of conductive layers 410 and a plurality of metal vias 420.

In more detail, the first sensing shield structure 231 may include the plurality of conductive layers 410 arranged substantially parallel (or parallel) to the first surface 21. In addition, the first sensing shield structure 231 may include a plurality of non-conductive layers (or dielectric layers) alternately laminated with the plurality of conductive layers 410.

Referring to FIG. 4B, the first power feeding path 261 may be formed to penetrate the plurality of conductive layers 410 and a plurality of non-conductive layers. In this case, the first power feeding path 261 may be electrically separated from the first sensing shield structure 231.

In addition, the first sensing shield structure 231 may include the plurality of metal vias 420 arranged between the plurality of conductive layers 410.

In more detail, the first sensing shield structure 231 may include the plurality of metal vias 420 arranged to penetrate the plurality of non-conductive layers and connect at least some of the plurality of conductive layers 410.

In addition, it may be understood that the second sensing shield structure 232 according to embodiments has substantially the same (or the same) configuration as the first sensing shield structure 231.

The first sensing shield structure 231 has the structure described above, thereby reducing electrical interference (e.g., a surface wave) between the first sensing antenna 211 and the second antenna 220.

Thus, the antenna device 100A according to embodiments of the present disclosure may reduce performance degradation due to electrical interference between the first antenna 210 and the second antenna 220.

That is, the antenna device 100A may improve the radiation performance of the first antenna 210 and the second antenna 220 through the above-described configurations.

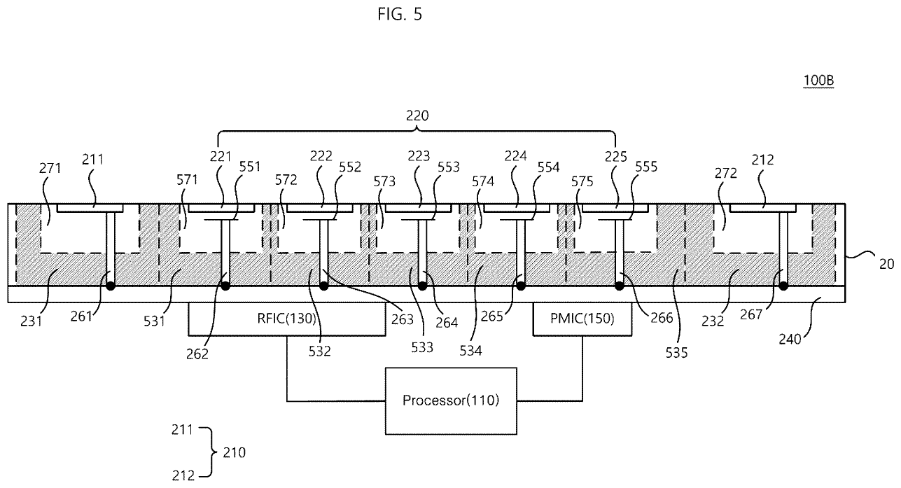

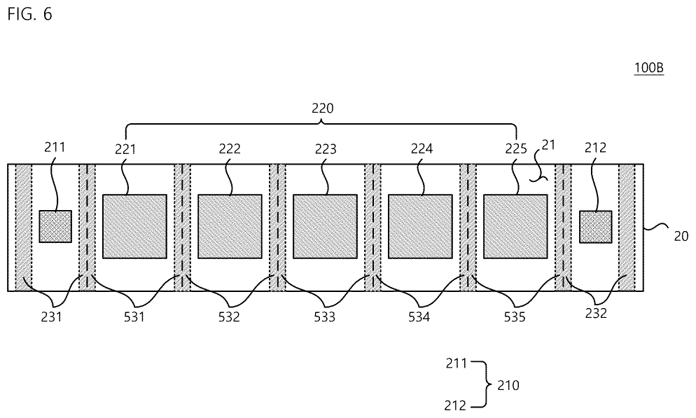

FIG. 5 is a cross-sectional view of an antenna device according to embodiments. FIG. 6 is a plan view illustrating the antenna device of FIG. 5.

Referring to FIG. 5 and FIG. 6 together, an antenna device 100B according to embodiments may include the printed circuit board 20, the first antenna 210, the second antenna 220, the RFIC 130, the processor 110, and/or the PMIC 150.

In this case, the antenna device 100B illustrated in FIGS. 5 and 6 may be understood as an example of the antenna device 100 illustrated in FIG. 1. In addition, it may be understood that the antenna device 100B illustrated in FIGS. 5 and 6 includes at least a portion of the configuration of the antenna device 100A illustrated in FIG. 2.

Therefore, the same reference numerals (or similar reference numerals) will be used for components that are identical or substantially identical to the components described above, and duplicate descriptions of the same components (or similar components) will be omitted.

Referring to FIG. 5, the antenna device 100B according to embodiments may include the first sensing shield structure 231, the second sensing shield structure 232, a first antenna shield structure 531, a second antenna shield structure 532, a third antenna shield structure 533, a fourth antenna shield structure 534, and/or a fifth antenna shield structure 535.

However, according to embodiments, at least one of the first antenna shield structure 531 to the fifth antenna shield structure 535 may be omitted. For example, the second antenna shield structure 532, the third antenna shield structure 533, and/or the fourth antenna shield structure 534 may be omitted.

In more detail, the antenna device 100B may include the first sensing shield structure 231 formed with the first groove 271 in which the first sensing antenna 211 is arranged. In addition, the antenna device 100B may include the second sensing shield structure 232 formed with the second groove 272 in which the second sensing antenna 212 is arranged.

In addition, the antenna device 100B may include the first antenna shield structure 531 forming a first antenna groove 571 in which the first antenna element 221 is arranged.

The first antenna shield structure 531 may have a shape forming the first antenna groove 571 that is opened through the first surface 21. The first antenna shield structure 531 may have a shape surrounding the first antenna groove 571.

In addition, the first antenna element 221 may be arranged within the first antenna groove 571. In more detail, the first antenna element 221 may be arranged within the first antenna groove 571 such that at least one surface is in contact with the outside of the printed circuit board 20 through the first surface 21 (e.g., is not covered by the first surface 21).

In this case, for example, the space excluding a space of the first antenna groove 571 where the first antenna element 221 is arranged may include a dielectric material. That is, the first antenna element 221 may be arranged to be surrounded by a dielectric material. According to embodiments, the first antenna shield structure 531 may include the dielectric material.

For another example, the first antenna element 221 may be arranged on the first surface 21.

Referring to FIGS. 5 and 6 together, at least a portion of the first antenna shield structure 531 may be arranged between the first sensing antenna 211 and the first antenna element 221.

In more detail, at least a portion of the first antenna shield structure 531 may form a portion of the first surface 21 of the printed circuit board 20. A portion of the first antenna shield structure 531 forming the first surface 21 may be arranged between the first sensing antenna 211 and the first antenna element 221 on the first surface 21.

That is, at least a portion of the first antenna shield structure 531 may be formed between the first sensing antenna 211 and the first antenna element 221 on the first surface 21.

In this case, for example, the first antenna shield structure 531 may be formed integrally with the first sensing shield structure 231.

In addition, at least a portion of the first antenna shield structure 531 may be arranged between the first antenna element 221 and the second antenna element 222.

In more detail, a portion of the first antenna shield structure 531 forming the first surface 21 may be arranged between the first antenna element 221 and the second antenna element 222 on the first surface 21.

Accordingly, the first antenna shield structure 531 according to embodiments may reduce electrical interference between the antenna elements formed through the first surface 21.

For example, the first antenna shield structure 531 may reduce electrical interference caused by a surface wave formed through the first surface 21 between the first sensing antenna 211 and the first antenna element 221 or the second antenna element 222.

In addition, the antenna device 100B may include the second antenna shield structure 532 forming a second antenna groove 572 in which the second antenna element 222 is arranged.

The second antenna shield structure 532 may have a shape forming the second antenna groove 572 that is opened through the first surface 21. The second antenna shield structure 532 may have a shape surrounding the second antenna groove 572.

In addition, the second antenna element 222 may be arranged within the second antenna groove 572. In more detail, the second antenna element 222 may be arranged within the second antenna groove 572 such that at least one surface is in contact with the outside of the printed circuit board 20 through the first surface 21 (e.g., is not covered by the first surface 21).

In this case, for example, the space excluding the space of the second antenna groove 572 where the second antenna element 222 is arranged may include a dielectric material. That is, the second antenna element 222 may be arranged to be surrounded by a dielectric material. According to embodiments, the second antenna shield structure 532 may include the dielectric material.

For another example, the second antenna element 222 may be arranged on the first surface 21.

Referring to FIGS. 5 and 6 together, at least a portion of the second antenna shield structure 532 may be arranged between the first antenna element 221 and the second antenna element 222.

In more detail, at least a portion of the second antenna shield structure 532 may form a portion of the first surface 21 of the printed circuit board 20. A portion of the second antenna shield structure 532 forming the first surface 21 may be arranged between the first antenna element 221 and the second antenna element 222 on the first surface 21.

That is, at least a portion of the second antenna shield structure 532 may be formed between the first antenna element 221 and the second antenna element 222 on the first surface 21.

In this case, for example, the second antenna shield structure 532 may be formed integrally with the first antenna shield structure 531.

In addition, at least a portion of the second antenna shield structure 532 may be arranged between the second antenna element 222 and the third antenna element 223.

In more detail, a portion of the second antenna shield structure 532 forming the first surface 21 may be arranged between the second antenna element 222 and the third antenna element 223 on the first surface 21.

Thus, the second antenna shield structure 532 according to embodiments may reduce electrical interference between the antenna elements formed through the first surface 21.

For example, the second antenna shield structure 532 may reduce electrical interference caused by a surface wave formed through the first surface 21 between the second antenna element 222 and the first antenna element 221 or the third antenna element 223.

In addition, the antenna device 100B may include the third antenna shield structure 533 forming a third antenna groove 573 in which the third antenna element 223 is arranged.

The third antenna shield structure 533 may have a shape forming the third antenna groove 573 that is opened through the first surface 21 (e.g., that forms an opening in the first surface 21). The third antenna shield structure 533 may have a shape surrounding the third antenna groove 573.

In addition, the third antenna element 223 may be arranged within the third antenna groove 573. In more detail, the third antenna element 223 may be arranged within the third antenna groove 573 such that at least one surface is in contact with the outside of the printed circuit board 20 through the first surface 21 (e.g., is not covered by the first surface 21).

In this case, for example, the space excluding the space of the third antenna groove 573 where the third antenna element 223 is arranged may include a dielectric material. That is, the third antenna element 223 may be arranged to be surrounded by a dielectric material. According to embodiments, the third antenna shield structure 533 may include the dielectric material For another example, the third antenna element 223 may be arranged on the first surface 21.

Referring to FIGS. 5 and 6 together, at least a portion of the third antenna shield structure 533 may be arranged between the second antenna element 222 and the third antenna element 223.

In more detail, at least a portion of the third antenna shield structure 533 may form a portion of the first surface 21 of the printed circuit board 20. A portion of the third antenna shield structure 533 forming the first surface 21 may be arranged between the second antenna element 222 and the third antenna element 223 on the first surface 21.

That is, at least a portion of the third antenna shield structure 533 may be formed between the second antenna element 222 and the third antenna element 223 on the first surface 21.

In this case, for example, the third antenna shield structure 533 may be formed integrally with the second antenna shield structure 532.

In addition, at least a portion of the third antenna shield structure 533 may be arranged between the third antenna element 223 and the fourth antenna element 224.

In more detail, a portion of the third antenna shield structure 533 forming the first surface 21 may be arranged between the third antenna element 223 and the fourth antenna element 224 on the first surface 21.

Thus, the third antenna shield structure 533 according to embodiments may reduce electrical interference between the antenna elements formed through the first surface 21.

For example, the third antenna shield structure 533 may reduce electrical interference caused by a surface wave formed through the first surface 21 between the third antenna element 223 and the second antenna element 222 or the fourth antenna element 224.

In addition, the antenna device 100B may include the fourth antenna shield structure 534 forming a fourth antenna groove 574 in which the fourth antenna element 224 is arranged.

The fourth antenna shield structure 534 may have a shape forming the fourth antenna groove 574 that is opened through the first surface 21 (e.g., that forms an opening in the first surface 21). The fourth antenna shield structure 534 may have a shape surrounding the fourth antenna groove 574.

In addition, the fourth antenna element 224 may be arranged within the fourth antenna groove 574. In more detail, the fourth antenna element 224 may be arranged within the fourth antenna groove 574 such that at least one surface is in contact with the outside of the printed circuit board 20 through the first surface 21 (e.g., is not covered by the first surface 21).

In this case, for example, the space excluding the space of the fourth antenna groove 574 where the fourth antenna element 224 is arranged may include a dielectric material. That is, the fourth antenna element 224 may be arranged to be surrounded by a dielectric material. According to embodiments, the fourth antenna shield structure 534 may include the dielectric material.

For another example, the fourth antenna element 224 may be arranged on the first surface 21.

Referring to FIGS. 5 and 6 together, at least a portion of the fourth antenna shield structure 534 may be arranged between the third antenna element 223 and the fourth antenna element 224.

In more detail, at least a portion of the fourth antenna shield structure 534 may form a portion of the first surface 21 of the printed circuit board 20. A portion of the fourth antenna shield structure 534 forming the first surface 21 may be arranged between the third antenna element 223 and the fourth antenna element 224 on the first surface 21.

That is, at least a portion of the fourth antenna shield structure 534 may be formed between the third antenna element 223 and the fourth antenna element 224 on the first surface 21.

In this case, for example, the fourth antenna shield structure 534 may be formed integrally with the third antenna shield structure 533.

In addition, at least a portion of the fourth antenna shield structure 534 may be arranged between the fourth antenna element 224 and the fifth antenna element 225.

In more detail, a portion of the fourth antenna shield structure 534 forming the first surface 21 may be arranged between the fourth antenna element 224 and the fifth antenna element 225 on the first surface 21.

Thus, the fourth antenna shield structure 534 according to embodiments may reduce electrical interference between the antenna elements formed through the first surface 21.

For example, the fourth antenna shield structure 534 may reduce electrical interference caused by a surface wave formed through the first surface 21 between the fourth antenna element 224 and the third antenna element 223 or the fifth antenna element 225.

In addition, the antenna device 100B may include the fifth antenna shield structure 535 forming a fifth antenna groove 575 in which the fifth antenna element 225 is arranged.

The fifth antenna shield structure 535 may have a shape forming the fifth antenna groove 575 that is opened through the first surface 21 (e.g., that forms an opening in the first surface 21). The fifth antenna shield structure 535 may have a shape surrounding the fifth antenna groove 575.

In addition, the fifth antenna element 225 may be arranged within the fifth antenna groove 575. In more detail, the fifth antenna element 225 may be arranged within the fifth antenna groove 575 such that at least one surface is in contact with the outside of the printed circuit board 20 through the first surface 21 (e.g., is not covered by the first surface 21).

In this case, for example, the space excluding the space of the fifth antenna groove 575 where the fifth antenna element 225 is arranged may include a dielectric material. That is, the fifth antenna element 225 may be arranged to be surrounded by a dielectric material. According to embodiments, the fifth antenna shield structure 535 may include the dielectric material.

For another example, the fifth antenna element 225 may be arranged on the first surface 21.

Referring to FIGS. 5 and 6 together, at least a portion of the fifth antenna shield structure 535 may be arranged between the fourth antenna element 224 and the fifth antenna element 225.

In more detail, at least a portion of the fifth antenna shield structure 535 may form a portion of the first surface 21 of the printed circuit board 20. A portion of the fifth antenna shield structure 535 forming the first surface 21 may be arranged between the fourth antenna element 224 and the fifth antenna element 225 on the first surface 21.

That is, at least a portion of the fifth antenna shield structure 535 may be formed between the fourth antenna element 224 and the fifth antenna element 225 on the first surface 21.

In this case, for example, the fifth antenna shield structure 535 may be formed integrally with the fourth antenna shield structure 534.

In addition, at least a portion of the fifth antenna shield structure 535 may be arranged between the fifth antenna element 225 and the second sensing antenna 212.

In more detail, a portion of the fifth antenna shield structure 535 forming the first surface 21 may be arranged between the fifth antenna element 225 and the second sensing antenna 212 on the first surface 21.

Thus, the fifth antenna shield structure 535 according to embodiments may reduce electrical interference between the antenna elements formed through the first surface 21.

For example, the fifth antenna shield structure 535 may reduce electrical interference caused by a surface wave formed through the first surface 21 between the fifth antenna element 225 and the fourth antenna element 224 or the second sensing antenna 212.

Referring to FIG. 5, the processor 110 may supply power to the first sensing antenna 211 through the first power feeding path 261 that penetrates the first sensing shield structure 231 and is connected to the first sensing antenna 211. Thus, the processor 110 may transmit a first signal through the first sensing antenna 211.

In addition, the processor 110 may supply power to the second sensing antenna 212 through the seventh power feeding path 267 that passes through the second sensing shield structure 232 and is connected to the second sensing antenna 212.

However, although it is described in FIG. 5 that the processor 110 supplies power through a power feeding path directly connected to each of the first sensing antenna 211 and the second sensing antenna 212, the scheme of supplying power is not limited to the above-described example.

As another example, the antenna device 100B may further include a coupling element arranged in the first groove 271, and the processor 110 may supply power to the first sensing antenna 211 through coupling power feeding through the coupling element.

In addition, the antenna device 100B according to embodiments may include a first antenna coupling element 551 arranged in the first antenna groove 571.

The processor 110 may supply power to the first antenna coupling element 551 through the second power feeding path 262 penetrating the first antenna shield structure 531. In this case, coupling may occur between the first antenna coupling element 551 and the first antenna element 221.

That is, the processor 110 may supply power to the first antenna element 221 through coupling power feeding by supplying power to the first antenna coupling element 551 through the second power feeding path 262.

In addition, the antenna device 100B may include a second antenna coupling element 552 arranged within the second antenna groove 572.

The processor 110 may supply power to the second antenna coupling element 552 through a third power feeding path 263 penetrating the second antenna shield structure 532. In this case, coupling may occur between the second antenna coupling element 552 and the second antenna element 222.

That is, the processor 110 may supply power to the second antenna element 222 through coupling power feeding by supplying power to the second antenna coupling element 552 through the third power feeding path 263.

In addition, the antenna device 100B may include a third antenna coupling element 553 arranged within the third antenna groove 573.

The processor 110 may supply power to the third antenna coupling element 553 through a fourth power feeding path 264 penetrating the third antenna shield structure 533. In this case, coupling may occur between the third antenna coupling element 553 and the third antenna element 223.

That is, the processor 110 may supply power to the third antenna element 223 through coupling power feeding by supplying power to the third antenna coupling element 553 through the fourth power feeding path 264.

In addition, the antenna device 100B according to embodiments may include a fourth antenna coupling element 554 arranged in the fourth antenna groove 574.

The processor 110 may supply power to the fourth antenna coupling element 554 through a fifth power feeding path 265 penetrating the fourth antenna shield structure 534. In this case, coupling may occur between the fourth antenna coupling element 554 and the fourth antenna element 224.

That is, the processor 110 may supply power to the fourth antenna element 224 through coupling power feeding by supplying power to the fourth antenna coupling element 554 through the fifth power feeding path 265.

In addition, the antenna device 100B may include a fifth antenna coupling element 555 arranged in the fifth antenna groove 575.

The processor 110 may supply power to the fifth antenna coupling element 555 through a sixth power feeding path 266 penetrating the fifth antenna shield structure 535. In this case, coupling may occur between the fifth antenna coupling element 555 and the fifth antenna element 225.

That is, the processor 110 may supply power to the fifth antenna element 225 through coupling power feeding by supplying power to the fifth antenna coupling element 555 through the sixth power feeding path 266.

However, it is described in FIG. 5 that the processor 110 supplies power to each of the plurality of antenna elements 221, 222, 223, 224, and 225 through coupling power feeding, the scheme of supplying power is not limited thereto.

For another example, the processor 110 may supply power to the first antenna element 221 through a power feeding path that penetrates the first antenna shield structure 531 and is directly connected to the first antenna element 221.

Referring to the above-described configurations, the antenna device 100B may include the shield structures 231, 232, 531, 532, 533, 534, and 535 forming a groove surrounding each of the first sensing antenna 211, the second sensing antenna 212, and the plurality of antenna elements 221, 222, 223, 224, and 225.

Thus, the antenna device 100B may reduce electrical interference between the first sensing antenna 211, the second sensing antenna 212, and the plurality of antenna elements 221, 222, 223, 224, and 225.

Therefore, the antenna device 100B according to embodiments of the present disclosure may improve the radiation performance of the first antenna 210 and the second antenna 220.

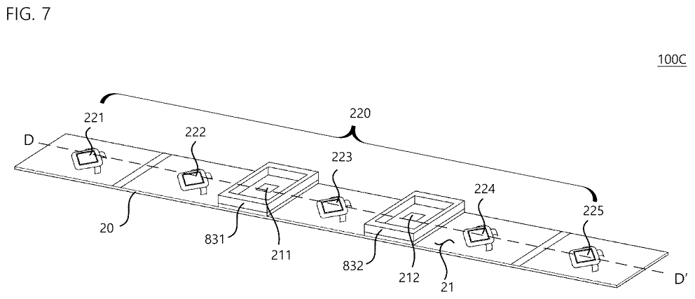

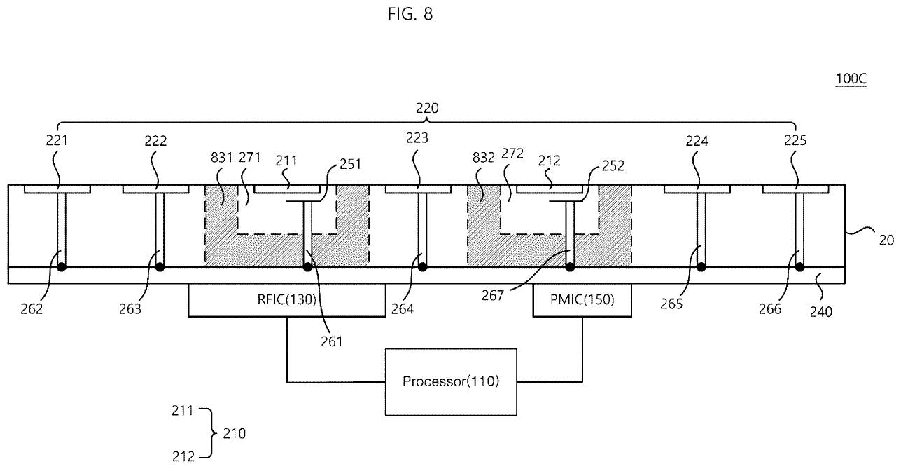

FIG. 7 is a perspective view of an antenna device according to embodiments. FIG. 8 is a cross-sectional view of the antenna device of FIG. 7 taken along line D-D′.

Referring to FIGS. 7 and 8 together, an antenna device 100C according to embodiments may include the printed circuit board 20, the first antenna 210, the second antenna 220, the RFIC 130, the processor 110, and/or the PMIC 150.

In this case, the antenna device 100C illustrated in FIGS. 7 and 8 may be understood as an example of the antenna device 100 illustrated in FIG. 1. In addition, it may be understood that the antenna device 100C illustrated in FIGS. 7 and 8 includes at least a portion of a configuration that is substantially the same as the configuration of the antenna device 100A illustrated in FIG. 2.

Therefore, the same reference numerals (or similar reference numerals) will be used for components that are identical or substantially identical to the components described above, and duplicate descriptions will be omitted.

According to embodiments, the first antenna 210 may include the first sensing antenna 211 and the second sensing antenna 212.

The first sensing antenna 211 and the second sensing antenna 212 may be arranged on the first surface 21 of the printed circuit board 20.

Referring to FIG. 8, the first sensing antenna 211 and the second sensing antenna 212 may be arranged to allow at least a portion of each surface thereof to be in contact with an outside of the printed circuit board 20 through the first surface 21 of the printed circuit board 20 (e.g., at least a portion of each surface thereof is not covered by the first surface 21).

In addition, the first sensing antenna 211 and the second sensing antenna 212 may be arranged spaced apart from each other on the first surface 21 of the printed circuit board 20.

In addition, the second antenna 220 may include the plurality of antenna elements 221, 222, 223, 224, and 225.

The plurality of antenna elements 221, 222, 223, 224, and 225 may be formed on the first surface 21 of the printed circuit board 20.

Referring to FIG. 8, each of the plurality of antenna elements 221, 222, 223, 224, and 225 may be arranged such that at least a portion of the surface is in contact with the outside of the printed circuit board 20 through the first surface 21 of the printed circuit board 20 (e.g., at least a portion of the surface is not covered by the first surface 21).

Each of the first sensing antenna 211 and the second sensing antenna 212 may be arranged between two adjacent antenna elements among the plurality of antenna elements 221, 222, 223, 224, and 225.

For example, the first sensing antenna 211 may be arranged between the second antenna element 222 and the third antenna element 223, and the second sensing antenna 212 may be arranged between the third antenna element 223 and the fourth antenna element 224.

However, the arrangement of each of the first sensing antenna 211, the second sensing antenna 212, and the plurality of antenna elements 221, 222, 223, 224, and 225 is not limited to the examples described above.

For another example, the first sensing antenna 211 may be arranged between the first antenna element 221 and the second antenna element 222, and the second sensing antenna 212 may be arranged between the fourth antenna element 224 and the fifth antenna element 225.

The antenna device 100C according to embodiments may include a first sensing shield structure 831 and a second sensing shield structure 832.

In more detail, the antenna device 100C may include the first sensing shield structure 831 formed with the first groove 271 in which the first sensing antenna 211 is arranged. In this case, the first sensing shield structure 831 may be understood to have substantially the same structure as (or the same structure as) the first sensing shield structure 231 of FIG. 3C.

The first sensing shield structure 831 may have a shape forming the first groove 271 that is opened through the first surface 21 (e.g., that forms an opening in the first surface 21). The first sensing shield structure 831 may have a shape surrounding the first groove 271.

In addition, the first sensing antenna 211 may be arranged within the first groove 271.

In more detail, the first sensing antenna 211 may be arranged within the first groove 271 such that at least one surface is in contact with the outside of the printed circuit board 20 through the first surface 21 (e.g., is not covered by the first surface 21).

In this case, for example, the space excluding a space of the first groove 271 where the first sensing antenna 211 is arranged may include a dielectric material. That is, the first sensing antenna 211 may be arranged to be surrounded by a dielectric material. According to embodiments, the first sensing shield structure 831 may include the dielectric material.

For another example, the first sensing antenna 211 may be arranged on the first surface 21 of the printed circuit board 20.

Referring to FIG. 8, at least a portion of the first sensing shield structure 831 may be arranged between the first sensing antenna 211 and the second antenna element 222. In addition, at least a portion of the first sensing shield structure 831 may be arranged between the first sensing antenna 211 and the third antenna element 223.

In more detail, at least a portion of the first sensing shield structure 831 may form a portion of the first surface 21 of the printed circuit board 20. In addition, a portion of the first sensing shield structure 831 forming the first surface 21 may be arranged between the first sensing antenna 211 and the second antenna element 222 on the first surface 21. In addition, a portion of the first sensing shield structure 831 forming the first surface 21 may be arranged between the first sensing antenna 211 and the third antenna element 223 on the first surface 21.

That is, a portion of the first sensing shield structure 831 may be formed between the first sensing antenna 211 and the second antenna element 222 on the first surface 21. In addition, a portion of the first sensing shield structure 831 may be formed between the first sensing antenna 211 and the third antenna element 223 on the first surface 21.

Thus, the first sensing shield structure 831 according to embodiments may reduce electrical interference between the first sensing antenna 211 formed through the first surface 21, and the second antenna element 222 and/or the third antenna element 223.

In addition, the antenna device 100C may include the second sensing shield structure 832 forming the second groove 272 in which the second sensing antenna 212 is arranged. In this case, the second sensing shield structure 832 may be understood to have substantially the same structure as (or the same structure as) the second sensing shield structure 232 of FIG. 3C.

The second sensing shield structure 832 may have a shape forming the second groove 272 that is opened through the first surface 21 (e.g., that forms an opening in the first surface 21). The second sensing shield structure 832 may have a shape surrounding the second groove 272.

In addition, the second sensing antenna 212 may be arranged within the second groove 272.

In more detail, the second sensing antenna 212 may be arranged within the second groove 272 such that at least one surface is in contact with the outside of the printed circuit board 20 through the first surface 21 (e.g., is not covered by the first surface 21).

In this case, for example, the space excluding a space of the second groove 272 where the second sensing antenna 212 is arranged may include a dielectric material. That is, the second sensing antenna 212 may be arranged to be surrounded by a dielectric material. According to embodiments, the second sensing shield structure 832 may include the dielectric material.

For another example, the second sensing antenna 212 may be arranged on the first surface 21 of the printed circuit board 20.

Referring to FIG. 8, at least a portion of the second sensing shield structure 832 may be arranged between the second sensing antenna 212 and the third antenna element 223. In addition, at least a portion of the second sensing shield structure 832 may be arranged between the second sensing antenna 212 and the fourth antenna element 224.

In more detail, at least a portion of the second sensing shield structure 832 may form a portion of the first surface 21 of the printed circuit board 20. In addition, a portion of the second sensing shield structure 832 forming the first surface 21 may be arranged between the second sensing antenna 212 and the third antenna element 223 on the first surface 21. In addition, a portion of the second sensing shield structure 832 forming the first surface 21 may be arranged between the second sensing antenna 212 and the fourth antenna element 224 on the first surface 21.

That is, a portion of the second sensing shield structure 832 may be formed between the second sensing antenna 212 and the third antenna element 223 on the first surface 21. In addition, a portion of the second sensing shield structure 832 may be formed between the second sensing antenna 212 and the fourth antenna element 224 on the first surface 21.

Thus, the second sensing shield structure 832 according to embodiments may reduce electrical interference between the second sensing antenna 212 formed through the first surface 21, and the third antenna element 223 and/or the fourth antenna element 224.

According to the above-described configurations, the antenna device 100C according to embodiments of the present disclosure may reduce performance degradation due to electrical interference between the first antenna 210 and the second antenna 220.

That is, the antenna device 100C may improve the radiation performance of the first antenna 210 and the second antenna 220 through the above-described configurations.

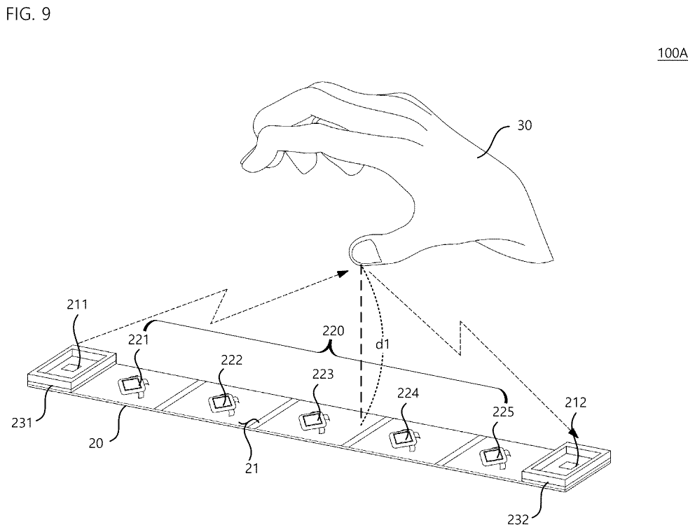

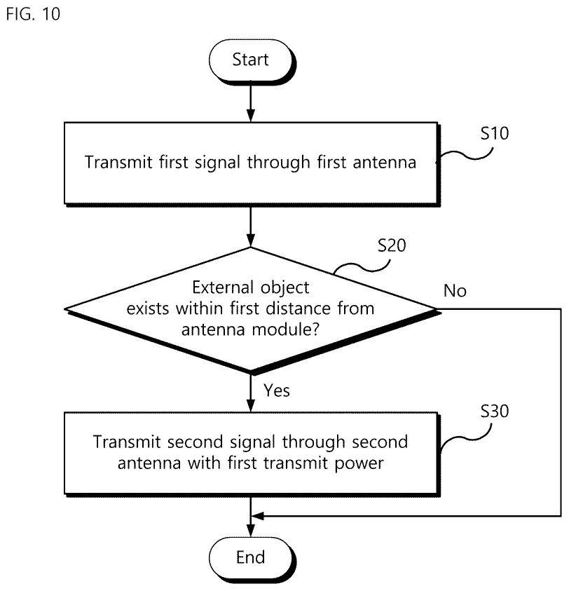

FIG. 9 is a perspective view of an antenna device for detecting an external object according to embodiments. FIG. 10 is a flowchart illustrating a method of controlling transmission power of an antenna device based on distance information between an external object and the antenna device according to embodiments.

Referring to FIGS. 9 and 10 together, the processor 110 (or the antenna device 100A) according to embodiments may control transmission power for transmitting the second signal through the second antenna 220 based on the distance between an external object 30 and the antenna device 100A.

In this case, it may be understood that the antenna device 100A illustrated in FIG. 9 has substantially the same configuration as (or the same configuration as) the antenna device 100A illustrated in FIG. 2. Therefore, the same reference numerals (or similar reference numerals) will be used for components that are identical or substantially identical to the components described above, and duplicate descriptions will be omitted.

According to embodiments, when the external object 30 exists (or is positioned) within a first distance (d1) from the antenna device 100A, the processor 110 may control the transmission power for transmitting the second signal through the second antenna 220 to be less than or equal to the first maximum (or highest) power set for the first distance.

In operation S10, the processor 110 may transmit the first signal through the first antenna 210.

In more detail, the processor 110 may transmit the first signal through the first sensing antenna 211 of the first antenna 210.

Referring to FIGS. 2, 9 and 10 together, the processor 110 may transmit the first signal through the first sensing antenna 211 by supplying power to the first sensing antenna 211 through the first power feeding path 261 penetrating the first sensing shield structure 231.

For example, the processor 110 may transmit the first signal having a frequency band of about 60 GHz through the first sensing antenna 211. In this case, for example, the first signal may be referenced as a radar signal for identifying the external object 30.

In operation S20, the processor 110 may determine whether the external object 30 exists (e.g., is positioned) within a first distance d1 from the antenna device 100A.

In more detail, the processor 110 may receive the first signal reflected in the external object 30 and determine whether the external object 30 exists (or is positioned) within the first distance d1 from the antenna device 100A.

In this case, the processor 110 may receive the first signal reflected in the external object 30 (may also be referred to herein as the reflected signal) through the second sensing antenna 212. According to embodiments, the processor 110 may receive a reflected signal through the second sensing antenna 212, where the reflected signal corresponds to the first signal transmitted from the first sensing antenna 211 reflected by the external object 30.

For example, the processor 110 may determine whether the external object 30 exists within the first distance d1 from the antenna device 100A based on the distance between the first sensing antenna 211 and the second sensing antenna 212 and the time taken from when the first signal is transmitted to when the first signal is received.

In operation S30, the processor 110 may transmit the second signal through the second antenna 220 at the first transmission power.

In more detail, when the external object 30 exists within the first distance d1 from the antenna device 100A, the processor 110 may transmit the second signal through the second antenna 220 at the first transmission power that is less than or equal to the first maximum (or highest) power set for the first distance d1.

In this case, for example, the maximum (or highest) power set according to the distance may be understood as the allowable power set to satisfy the standards for at least some of the specific absorption rate (SAR), power density (PD), and/or total exposure rate (TER).

For example, the first maximum (or highest) power may be set such that the total exposure rate of the external object 30 located the first distance d1 away from the antenna device 100A to the electromagnetic wave radiated by the antenna device 100A is less than a reference value.

In addition, for example, the maximum (or highest) power according to the distance between the antenna device 100A and the external object 30 may be stored in the form of a lookup table. Accordingly, the antenna device 100A or an electronic device including the antenna device 100A may further include a memory for storing the lookup table.

However, the form and configuration in which the maximum (or highest) power is stored according to the distance between the antenna device 100A and the external object 30 are not limited to the examples described above.

For example, the second signal may be understood as an mmWave signal having a frequency band of about 28 GHz in a 5G network, but embodiments are not limited thereto. According to embodiments, the frequency of the first signal may be different from the frequency of the second signal.

Referring to the above-described configurations, the processor 110 according to embodiments may transmit an RF signal through the second antenna 220 at a transmission power less than or equal to the maximum (or highest) power set according to the distance between the external object 30 and the antenna device 100A.

Thus, the antenna device 100A according to the present disclosure may improve the power efficiency of wireless communication within a range that satisfies the standards related to a human body adjacent to the antenna device 100A.

According to embodiments, in operation S30, the processor 110 may transmit the second signal through the second antenna 220 at the first transmission power to an external device. For example, the processor 110 may generate a first signal, process the first signal to perform one or more among modulating, upconverting, filtering, amplifying and/or encrypting on the first signal (e.g., using the RFIC 130 and/or the RFFE 120), and transmit the processed first signal to the external device through the second antenna 220 at the first transmission power. Additionally, the processor 110 may receive a second signal from the external device via the second antenna 220 (e.g., in response to the first signal), process the second signal to perform one or more among demodulating, downconverting, filtering, amplifying and/or decrypting on the second signal (e.g., using the RFIC 130 and/or the RFFE 120), and perform a further operation(s) based on the processed second signal. For example, the further operation(s) may include one or more of providing the processed second signal to a corresponding application being executed by the processor 110, storing the processed second signal in a memory, sending a response signal to the external device (e.g., based on a processing result of the corresponding application being executed by the processor 110), etc.

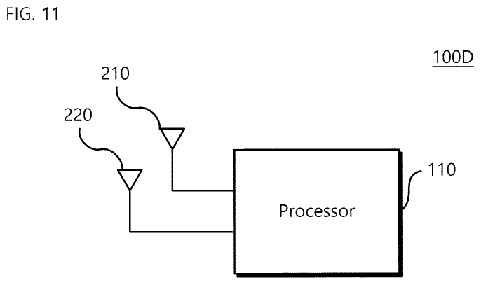

FIG. 11 is a block diagram illustrating an antenna device according to embodiments.

Referring to FIG. 11, an antenna device 100D according to embodiments may include the first antenna 210, the second antenna 220, and/or the processor 110.

The antenna device 100D of FIG. 11 may be referenced as an example of the antenna device 100 of FIG. 1. In addition, it may be understood that the antenna device 100D illustrated in FIG. 11 includes a configuration substantially identical to (or identical to) at least a portion of the antenna device 100A illustrated in FIG. 2.

Therefore, the same reference numerals (or similar reference numerals) will be used for components that are identical or substantially identical to the components described above, and duplicate descriptions will be omitted.

The antenna device 100D according to embodiments may include the first antenna 210 including the first sensing antenna 211 and the second sensing antenna 212.

In more detail, the antenna device 100D may include the first sensing antenna 211 and the second sensing antenna 212 arranged on the first surface 21 of the printed circuit board 20.

The antenna device 100D may include the second antenna 220 arranged on the first surface 21 of the printed circuit board 20.

In more detail, the antenna device 100D may include the second antenna 220 that includes the plurality of antenna elements 221, 222, 223, 224, and 225 arranged on the first surface 21 of the printed circuit board 20.

For example, the second antenna 220 may include the plurality of antenna elements 221, 222, 223, 224, and 225 arranged between the first sensing antenna 211 and the second sensing antenna 212 on the first surface 21.

The antenna device 100D may include the processor 110 electrically connected to the printed circuit board 20, the first antenna 210, and the second antenna 220.

According to embodiments, the processor 110 may transmit and receive the first signal by using the first antenna 210.

In more detail, the processor 110 may transmit and receive the first signal of a first frequency band (e.g., 60 GHz) by using the first sensing antenna 211 and the second sensing antenna 212.

For example, the processor 110 may transmit the first signal by using the first sensing antenna 211. In addition, the processor 110 may receive the first signal by using the second sensing antenna 212.

In addition, the processor 110 may transmit the second signal by using the second antenna 220.

In more detail, the processor 110 may transmit the second signal of a second frequency band (e.g., 28 GHz) through the plurality of antenna elements 221, 222, 223, 224, and 225.

Referring to the above-described configurations, the antenna device 100 may include the first antenna 210 and the second antenna 220 that transmit and receive signals of different frequency bands. In this case, the first antenna 210 and the second antenna 220 may be implemented on a single printed circuit board.

Therefore, the antenna device 100D according to embodiments of the present disclosure may have a relatively small area (e.g., relatively small dimensions) compared to the case where the antennas 210 and 220 for transmitting and receiving signals of different frequency bands are arranged on separate printed circuit boards.

In addition, referring to FIGS. 3A and 11 together, the antenna device 100D may include the first sensing shield structure 231 and the second sensing shield structure 232.

In more detail, the antenna device 100D may include the first sensing shield structure 231 formed with the first groove 271 in which the first sensing antenna 211 is arranged.

In this case, the first sensing shield structure 231 may have a shape surrounding the first groove 271.

In addition, the first sensing antenna 211 may be arranged within the first groove 271. In more detail, the first sensing antenna 211 may be arranged within the first groove 271 such that at least one surface is in contact with the outside of the printed circuit board 20 through the first surface 21.

At least a portion of the first sensing shield structure 231 may be arranged between the first sensing antenna 211 and the first antenna element 221.

In more detail, at least a portion of the first sensing shield structure 231 may form a portion of the first surface 21 of the printed circuit board 20. In addition, a portion of the first sensing shield structure 231 forming the first surface 21 may be arranged between the first sensing antenna 211 and the first antenna element 221 on the first surface 21.

That is, at least a portion of the first sensing shield structure 231 may be formed between the first sensing antenna 211 and the first antenna element 221 on the first surface 21.

Accordingly, the first sensing shield structure 231 according to embodiments may reduce electrical interference between the first sensing antenna 211 formed through the first surface 21 and the first antenna element 221 (or, the second antenna 220).

In addition, the antenna device 100D may include the second sensing shield structure 232 forming the second groove 272 in which the second sensing antenna 212 is arranged.

In this case, the second sensing shield structure 232 may have a shape surrounding the second groove 272.

In addition, the second sensing antenna 212 may be arranged within the second groove 272. In more detail, the second sensing antenna 212 may be arranged within the second groove 272 such that at least one surface thereof is in contact with the outside of the printed circuit board 20 through the first surface 21.

In this case, for example, the space excluding the space of the second groove 272 where the second sensing antenna 212 is arranged may include a dielectric material. That is, the second sensing antenna 212 may be arranged to be surrounded by a dielectric material.

At least a portion of the second sensing shield structure 232 may be arranged between the second sensing antenna 212 and the fifth antenna element 225.

In more detail, at least a portion of the second sensing shield structure 232 may form a portion of the first surface 21 of the printed circuit board 20. In addition, a portion of the second sensing shield structure 232 forming the first surface 21 may be arranged between the second sensing antenna 212 and the fifth antenna element 225 on the first surface 21.

That is, at least a portion of the second sensing shield structure 232 may be formed between the second sensing antenna 212 and the fifth antenna element 225 on the first

### Surface 21.

Referring to the above-described configurations, the second sensing shield structure 232 according to embodiments may reduce electrical interference between the second sensing antenna 212 formed through the first surface 21 and the fifth antenna element 225 (or, the second antenna 220).

Through the above-described configurations, the antenna device 100D according to embodiments of the present disclosure may reduce performance degradation due to electrical interference between the first antenna 210 and the second antenna 220. That is, the antenna device 100D may improve the radiation performance of the first antenna 210 and the second antenna 220 through the above-described configurations.

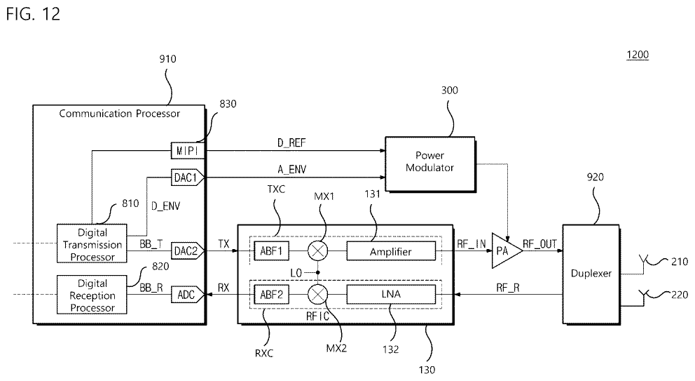

FIG. 12 is a block diagram illustrating an electronic device according to embodiments.

Referring to FIG. 12, a wireless communication device 1200 according to embodiments of the present disclosure may include a communication processor 910, the RFIC 130, a power modulator 300, a duplexer 920, a power amplifier (PA), the first antenna 210, and/or the second antenna 220.

In this case, it may be understood that the wireless communication device 1200 illustrated in FIG. 12 includes at least a portion of the configuration of the antenna device 100A illustrated in FIG. 2. Therefore, the same reference numerals (or similar reference numerals) will be used for components that are identical or substantially identical to the components described above, and duplicate descriptions of the same components (or similar components) will be omitted.

The communication processor 910 may process a baseband signal BB_T through a digital transmission processor 810 therein according to a specified communication scheme. In addition, the communication processor 910 may process a received baseband signal BB_R through a digital reception processor 820 according to the specified communication scheme.

For example, the communication processor 910 may process a signal to be transmitted or a signal received according to a communication scheme such as orthogonal frequency division multiplexing (OFDM), orthogonal frequency division multiplexing access (OFDMA), wideband code multiple access (WCDMA), high speed packet access+ (HSPA+), or the like. In addition, the communication processor 910 may process the baseband signal BB_T or BB_R according to various types of communication schemes (e.g., various communication schemes to which a technology for modulating or demodulating the amplitude and frequency of the baseband signal BB_T or BB_R is applied).

The communication processor 910 may extract the envelope of the baseband signal BB_T through the digital transmission processor 810 and generate a digital envelope signal D_ENV based on the extracted envelope. In addition, the communication processor 910 may generate an average power signal D_REF based on an average power tracking table stored in a memory. In this case, the extracted envelope may correspond to the amplitude components (e.g., the magnitudes of I and Q signals) of the baseband signal BB_T.

In this case, the communication processor 910 may perform digital/analog conversion on the baseband signal BB_T and the digital envelope signal D_ENV by using a plurality of digital/analog converters DAC1 and DAC2 provided therein, thereby generating a transmission signal TX and an analog envelope signal A_ENV, which are analog signals. The average power signal D_REF output from the communication processor 910 may be a digital signal. Accordingly, the average power signal D_REF may be provided to a digital/analog converter provided in the power modulator 300 via a mobile industry processor interface (MIPI) 830, and may be converted into an analog signal, such as a reference voltage signal, through the digital/analog converter provided in the power modulator 300. For reference, the digital/analog converters DAC1 and DAC2 provided in the communication processor 910 may operate at a higher speed than the digital/analog converter provided in the power modulator 300.

However, embodiments are not limited thereto, and the communication processor 910 may convert the average power signal D_REF into an analog signal and output the analog signal through a digital/analog converter provided therein. In this case, the communication processor 910 may provide the average power signal converted into an analog signal to the power modulator 300 as a reference voltage signal.

However, for convenience of explanation, in embodiments of the present disclosure, it will be described as an example that the communication processor 910 provides the average power signal D_REF to the digital/analog converter provided in the power modulator 300 through the MIPI 830.

For reference, the transmission signal TX and the analog envelope signal A_ENV may be differential signals including positive and negative signals, respectively.

In addition, the communication processor 910 may receive a reception signal RX, which is an analog signal, from the RFIC 130. In addition, the communication processor 910 may convert the reception signal RX into analog/digital through an analog/digital converter (ADC) provided therein to extract the baseband signal BB_R, which is a digital signal. In this case, the reception signal RX may be a differential signal including a positive signal and a negative signal.

The RFIC 130 may generate an RF input signal RF_IN by performing frequency up-conversion on the transmission signal TX or may generate the reception signal RX by performing frequency down-conversion on an RF reception signal RF_R. In detail, the RFIC 130 may include a transmitter circuit TXC for frequency up-conversion, a receiver circuit RXC for frequency down-conversion, and/or a local oscillator LO.

In this case, the transmitter circuit TXC may include a first analog baseband filter ABF1, a first mixer MX1, and/or an amplifier 131. For example, the first analog baseband filter ABF1 may include a low pass filter.

The first analog baseband filter ABF1 may filter the transmission signal TX received from the communication processor 910 and provide it to the first mixer MX1. In addition, the first mixer MX1 may perform frequency up-conversion to convert the frequency of the transmission signal TX from a baseband to a higher frequency band by using a frequency signal provided by the local oscillator LO. Through such frequency up-conversion, the transmission signal TX may be provided to the amplifier 131 as the RF input signal RF_IN, and the amplifier 131 may primarily power-amplify the RF input signal RF_IN and provide it to the power amplifier PA.

The power amplifier PA may receive a power voltage (e.g., a dynamically variable output voltage) from the power modulator 300, and may secondarily amplify the power of the RF input signal RF_IN based on the received power voltage to generate an RF output signal RF_OUT. In addition, the power amplifier PA may provide the generated RF output signal RF_OUT to the duplexer 920.

The receiver circuit RXC may include a second analog baseband filter ABF2, a second mixer MX2, and/or a low-noise amplifier 132. For example, the second analog baseband filter ABF2 may include a low-pass filter.

The low-noise amplifier 132 may amplify the RF reception signal RF_R provided from the duplexer 920 and provide it to the second mixer MX2. In addition, the second mixer MX2 may perform frequency down-conversion to convert the frequency of the received signal RF_R from a higher frequency band to a base band by using the frequency signal provided from the local oscillator LO. Through such frequency down-conversion, the RF reception signal RF_R may be provided to the second analog baseband filter ABF2 as the reception signal RX, and the second analog baseband filter ABF2 may filter the reception signal RX and provide it to the communication processor 910.

For reference, the wireless communication device 1200 may transmit a transmission signal through multiple frequency bands by using carrier aggregation (CA). In addition, to this end, the wireless communication device 1200 may include a plurality of power amplifiers that power amplify the plurality of RF input signals RF_IN corresponding to each of a plurality of carriers. However, in embodiments of the present disclosure, for convenience of explanation, an example in which there is only one power amplifier PA will be described.

The power modulator 300 may generate a modulated output voltage the level of which dynamically changes based on the analog envelope signal A_ENV and the average power signal D_REF, and provide the modulated output voltage to the power amplifier PA as a power voltage.

In detail, the power modulator 300 may receive the average power signal D_REF and the analog envelope signal A_ENV from the communication processor 910. In addition, the power modulator 300 may be driven in one tracking mode among an ET mode and/or an APT mode based on the average power signal D_REF and the analog envelope signal A_ENV received, thereby generating a dynamically variable output voltage. Further, the power modulator 300 may supply the generated output voltage to the power amplifier PA as a power voltage.

For reference, when a fixed level of power source voltage is applied to the power amplifier PA, the power efficiency of the power amplifier PA may be reduced. Therefore, for efficient power management of the power amplifier PA, the power modulator 300 may modulate the input voltage (e.g., power provided from a battery) based on at least one of the analog envelope signal A_ENV and the average power signal D_REF, and provide the modulated voltage to the power amplifier PA as a power voltage.

The duplexer 920 may separate the RF output signal RF_OUT provided from the power amplifier PA by frequency band and provide it to the corresponding antennas 210 and 220. In addition, the duplexer 920 may provide an external signal received from the first antenna 210 and/or the second antenna 220 to the low-noise amplifier 132 included in the receiver circuit RXC of the RFIC 130.

According to embodiments, the duplexer 920 may include the power amplifier PA.

Each of the first antenna 210 and/or the second antenna 220 may transmit the RF output signal RF_OUT to the outside (e.g., outside of the wireless communication device 1200) or provide the RF reception signal RF_R received from the outside to the RFIC 130.

Referring to FIG. 2 and FIG. 12 together, the first antenna 210 may include the first sensing antenna 211 and the second sensing antenna 212 that are arranged to be spaced apart from each other on the first surface 21 of the printed circuit board 20.

In addition, the second antenna 220 may include the plurality of antenna elements 221, 222, 223, 224, and 225 arranged between the first sensing antenna 211 and the second sensing antenna 212 on the first surface 21 of the printed circuit board 20.

In addition, the wireless communication device 1200 may include the first sensing shield structure 231.

In more detail, the wireless communication device 1200 may include the first sensing shield structure 231 formed with the first groove 271 in which the first sensing antenna 211 is arranged.

In this case, the first sensing shield structure 231 may have a shape surrounding the first groove 271.

In addition, the first sensing antenna 211 may be arranged within the first groove 271. In more detail, the first sensing antenna 211 may be arranged within the first groove 271 such that at least one surface is in contact with the outside of the printed circuit board 20 through the first surface 21.

At least a portion of the first sensing shield structure 231 may be arranged between the first sensing antenna 211 and the first antenna element 221.

In more detail, at least a portion of the first sensing shield structure 231 may form a portion of the first surface 21 of the printed circuit board 20. In addition, a portion of the first sensing shield structure 231 forming the first surface 21 may be arranged between the first sensing antenna 211 and the first antenna element 221 on the first surface 21.

That is, at least a portion of the first sensing shield structure 231 may be formed between the first sensing antenna 211 and the first antenna element 221 on the first surface 21.

Accordingly, the first sensing shield structure 231 according to embodiments may reduce electrical interference between the first sensing antenna 211 formed through the first surface 21 and the first antenna element 221 (or, the second antenna 220).

That is, the wireless communication device 1200 according to embodiments of the present disclosure may reduce performance degradation due to electrical interference between the first antenna 210 and the second antenna 220. The wireless communication device 1200 may improve the radiation performance of the first antenna 210 and the second antenna 220 through the above-described configurations.

For reference, the communication processor 910, the power modulator 300, the RFIC 130, the power amplifier PA, and/or the duplexer 920 may be individually implemented as an IC, chip or a module. In addition, the communication processor 910, the power modulator 300, the RFIC 130, the power amplifier PA, and/or the duplexer 920 may be mounted together on the printed circuit board 20. However, the technical idea of the present disclosure is not limited thereto, and in embodiments, at least some of the communication processor 910, the power modulator 300, the RFIC 130, the power amplifier PA, and/or the duplexer 920 may be implemented in a single communication chip.

Furthermore, the wireless communication device 1200 illustrated in FIG. 12 may be included in a wireless communication system using a cellular network such as 5G, LTE, or the like, and may also be included in a wireless local area network (WLAN) system or any other wireless communication system. For reference, the configuration of the wireless communication device 1200 illustrated in FIG. 12 is merely an example and may be configured in various manners depending on the communication protocol or communication scheme, but embodiments are not limited thereto.

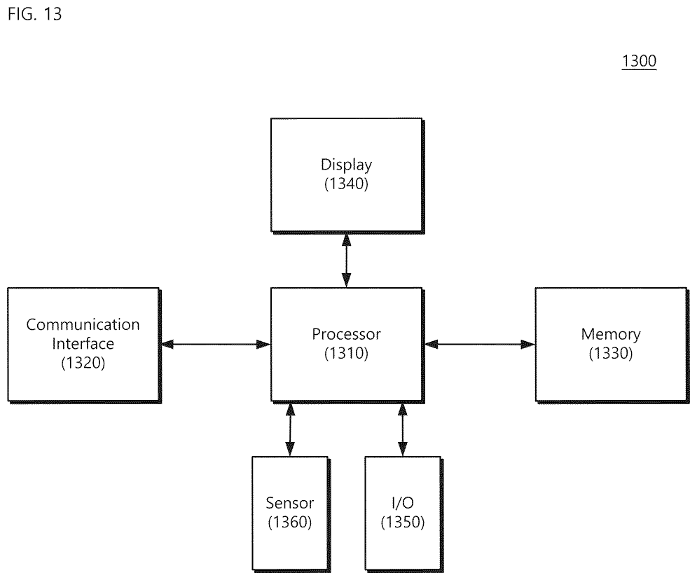

FIG. 13 is a block diagram illustrating an IoT device including an electronic device according to embodiments.

Referring to FIG. 13, Internet of things (IoT) may refer to a network between objects using wired/wireless communication. An IoT device 1300 may include devices having an accessible wired or wireless interface and communicating with at least one other device through the wired or wireless interface to transmit or receive data. The accessible interface of the IoT device 1300 may include a wired local area network (LAN), a wireless local area network (WLAN) such as Wi-Fi, a wireless personal area network (WPAN) such as Bluetooth, a wireless universal serial bus (USB), ZigBee, near field communication (NFC), radio frequency identification (RFID), power line communication (PLC), or a modem communication interface connectable to a mobile cellular network such as 3G, LTE, 4G, or 5G. The Bluetooth interface may support Bluetooth low energy (BLE).

In detail, the IoT device 1300 may include a communication interface 1320 for communicating with an outside (e.g., with another device external to the IoT device 1300). For example, the communication interface 1320 may be a wired local area network (LAN), a wireless local area communication interface such as Bluetooth, Wi-Fi, ZigBee, PLC, or a modem communication interface connectable to a mobile cellular network such as 3G, LTE, 4G, or 5G.

The communication interface 1320 may include a transceiver and/or a receiver. In this case, it may be understood that the communication interface 1320 illustrated in FIG. 13 includes at least a portion of the antenna device 100A illustrated in FIG. 2. For example, the communication interface 1320 may include the first antenna 210 and the second antenna 220.

The first antenna 210 may include the first sensing antenna 211 and the second sensing antenna 212 that are arranged to be spaced apart from each other on the first surface 21 of the printed circuit board 20.

In addition, the second antenna 220 may include the plurality of antenna elements 221, 222, 223, 224, and 225 arranged between the first sensing antenna 211 and the second sensing antenna 212 on the first surface 21 of the printed circuit board 20.

In addition, the IoT device 1300 may include the first sensing shield structure 231.

In more detail, the IoT device 1300 may include the first sensing shield structure 231 formed with the first groove 271 in which the first sensing antenna 211 is arranged.

In this case, the first sensing shield structure 231 may have a shape surrounding the first groove 271.

In addition, the first sensing antenna 211 may be arranged within the first groove 271. In more detail, the first sensing antenna 211 may be arranged within the first groove 271 such that at least one surface is in contact with the outside of the printed circuit board 20 through the first surface 21.

At least a portion of the first sensing shield structure 231 may be arranged between the first sensing antenna 211 and the first antenna element 221.

In more detail, at least a portion of the first sensing shield structure 231 may be formed between the first sensing antenna 211 and the first antenna element 221 on the first surface 21.

That is, at least a portion of the first sensing shield structure 231 may be formed between the first sensing antenna 211 and the first antenna element 221 on the first surface 21.

Accordingly, the first sensing shield structure 231 according to embodiments may reduce electrical interference between the first sensing antenna 211 formed through the first surface 21 and the first antenna element 221 (or, the second antenna 220).

That is, the IoT device 1300 according to embodiments of the present disclosure may reduce performance degradation due to electrical interference between the first antenna 210 and the second antenna 220. The IoT device 1300 may improve the radiation performance of the first antenna 210 and the second antenna 220 through the above-described configurations.

The IoT device 1300 may transmit and/or receive information from an access point or a gateway through a transmitter and/or a receiver. In addition, the IoT device 1300 may communicate with a user device or another IoT device to transmit and/or receive control information or data of the IoT device 1300.

The IoT device 1300 may include a processor 1310 that performs an operation. In this case, it may be understood that the processor 1310 has substantially the same configuration as (or the same configuration as) the processor 110 illustrated in FIG. 1.

The IoT device 1300 may further include a power supply unit that has a built-in battery for internal power supply or receives power from an external source. In addition, the IoT device 1300 may include a display 1340 for displaying internal status or data. A user may control the IoT device 1300 through a user interface (UI) of the display 1340 of the IoT device 1300. The IoT device 1300 may transmit internal status and/or data to the outside (e.g., to another device external to the IoT device 1300) through a transmitter and may receive control commands and/or data from the outside through a receiver.

A memory 1330 may store control instruction codes, control data, or user data for controlling the IoT device 1300. The memory 1330 may include at least one of a volatile memory or a non-volatile memory. The non-volatile memory may include at least one of various memories, such as a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (ReRAM), a ferroelectric RAM (FRAM), and the like. The volatile memory may include at least one of various memories, such as a dynamic RAM (DRAM), a static RAM (SRAM), a synchronous DRAM (SDRAM), and the like.

The IoT device 1300 may further include a storage device. The storage device may include at least one of non-volatile media such as a hard disk drive (HDD), a solid state drive (SDD), an embedded multi-media card (eMMC), and/or universal flash storage (USF). The storage device may store user information provided through an input/output (I/O) unit 1350 and/or sensing information collected through a sensor 1360.

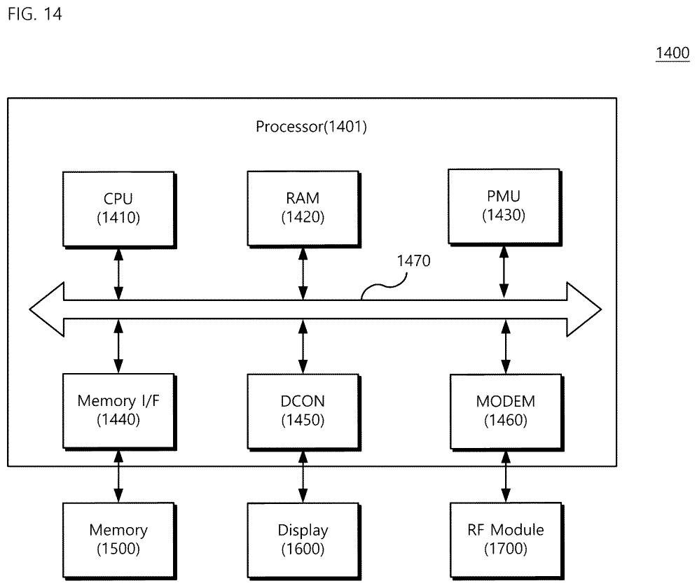

FIG. 14 is a block diagram illustrating a mobile terminal to which an electronic device according to embodiments is applied.

Referring to FIG. 14, a mobile terminal 1400 may include a processor 1401, a memory 1500, a display 1600, and/or a radio frequency (RF) module 1700. In addition, the mobile terminal 1400 may further include various components such as a lens, a sensor, an audio module, and the like.

The processor 1401 may be implemented as a system on chip (SoC) and may include a central processing unit (CPU) 1410, a RAM 1420, a power management unit (PMU) 1430, a memory interface (I/F) 1440, a display controller (DCON) 1450, a modem 1460, and/or a bus 1470. The processor 1401 may also include various IPs. The processor 1401 may be referred to as ModAP as the function of a modem chip is integrated therein, but embodiments are not limited thereto.

In this case, it may be understood that the processor 1401 illustrated in FIG. 14 has substantially the same configuration as (or the same configuration as) the processor 110 illustrated in FIG. 1.

The CPU 1410 may control the overall operation of the processor 1401 and the mobile terminal 1400. The CPU 1410 may control the operation of each component of the processor 1401. In addition, the CPU 1410 may be implemented as a multi-core. The multi-core is a computing component having two or more independent cores.

The RAM 1420 may temporarily store programs, data, or instructions. For example, programs and/or data stored in the memory 1500 may be temporarily stored in the RAM 1420 according to the control or booting code of the CPU 1410. The RAM 1420 may be implemented as DRAM or SRAM.

The PMU 1430 may manage the power of each component of the processor 1401. The PMU 1430 may also determine the operating status of each component of the processor 1401 and control the operation.

The memory interface 1440 may control the overall operation of the memory 1500 and control data exchange between each component of the processor 1401 and the memory 1500. The memory interface 1440 may write data to or read data from the memory 1500 according to the request of the CPU 1410.

The display controller 1450 may transmit image data to be displayed on the display 1600 to the display 1600. The display 1600 may be implemented as a flat display such as a liquid crystal display (LCD), an organic light emitting diode (OLED), or the like, or a flexible display.

The modem 1460 may modulate data to be transmitted to suit the wireless environment for wireless communication and may recover received data. The modem 1460 may perform digital communication with the RF module 1700.

The RF module 1700 may convert a higher frequency signal received through the antennas 210 and 220 into a lower frequency signal and transmit the converted lower frequency signal to the modem 1460. In addition, the RF module 1700 may convert a lower frequency signal received from the modem 1460 into a higher frequency signal and transmit the converted higher frequency signal to the outside of the mobile terminal 1400 through an antenna. The RF module 1700 may amplify or filter the signal.

In this case, the RF module 1700 may include at least a portion of the antenna device 100A illustrated in FIG. 2. For example, the RF module 1700 may include the first antenna 210 and the second antenna 220.

The first antenna 210 may include the first sensing antenna 211 and the second sensing antenna 212 that are arranged to be spaced apart from each other on the first surface 21 of the printed circuit board 20.

In addition, the second antenna 220 may include the plurality of antenna elements 221, 222, 223, 224, and 225 arranged between the first sensing antenna 211 and the second sensing antenna 212 on the first surface 21 of the printed circuit board 20.

In addition, the mobile terminal 1400 may include the first sensing shield structure 231.

In more detail, the mobile terminal 1400 may include the first sensing shield structure 231 formed with the first groove 271 in which the first sensing antenna 211 is arranged.

In this case, the first sensing shield structure 231 may have a shape surrounding the first groove 271.

In addition, the first sensing antenna 211 may be arranged within the first groove 271. In more detail, the first sensing antenna 211 may be arranged within the first groove 271 such that at least one surface is in contact with the outside of the printed circuit board 20 through the first surface 21.

At least a portion of the first sensing shield structure 231 may be arranged between the first sensing antenna 211 and the first antenna element 221.

In more detail, at least a portion of the first sensing shield structure 231 may be arranged between the first sensing antenna 211 and the first antenna element 221 on the first surface 21.

That is, at least a portion of the first sensing shield structure 231 may be formed between the first sensing antenna 211 and the first antenna element 221 on the first surface 21.

Accordingly, the first sensing shield structure 231 according to embodiments may reduce electrical interference between the first sensing antenna 211 formed through the first surface 21 and the first antenna element 221 (or, the second antenna 220).

That is, the mobile terminal 1400 according to embodiments of the present disclosure may reduce performance degradation due to electrical interference between the first antenna 210 and the second antenna 220. The mobile terminal 1400 may improve the radiation performance of the first antenna 210 and the second antenna 220 through the above-described configurations.

As described above, the first antenna 210 according to embodiments of the present disclosure may include the first sensing antenna 211 and the second sensing antenna 212 that are arranged to be spaced apart from each other on the first surface 21 of the printed circuit board 20.

In addition, the second antenna 220 may include the plurality of antenna elements 221, 222, 223, 224, and 225 arranged on the first surface 21 of the printed circuit board 20.

In addition, the antenna device 100 may include the first sensing shield structure 231

In more detail, the antenna device 100 may include the first sensing shield structure 231 formed with the first groove 271 in which the first sensing antenna 211 is arranged.

In this case, the first sensing shield structure 231 may have a shape surrounding the first groove 271.

In addition, the first sensing antenna 211 may be arranged within the first groove 271. In more detail, the first sensing antenna 211 may be arranged within the first groove 271 such that at least one surface is in contact with the outside of the printed circuit board 20 through the first surface 21.

At least a portion of the first sensing shield structure 231 may be arranged between the first sensing antenna 211 and the first antenna element 221.

In more detail, at least a portion of the first sensing shield structure 231 may form a portion of the first surface 21 of the printed circuit board 20. In addition, a portion of the first sensing shield structure 231 forming the first surface 21 may be arranged between the first sensing antenna 211 and the first antenna element 221 on the first surface 21.

That is, at least a portion of the first sensing shield structure 231 may be formed between the first sensing antenna 211 and the first antenna element 221 on the first surface 21.

Accordingly, the first sensing shield structure 231 according to embodiments may reduce electrical interference between the first sensing antenna 211 formed through the first surface 21 and the first antenna element 221 (or, the second antenna 220).

That is, the antenna device 100 according to embodiments of the present disclosure may reduce performance degradation due to electrical interference between the first antenna 210 and the second antenna 220. The antenna device 100 may improve the radiation performance of the first antenna 210 and the second antenna 220 through the above-described configurations.

An antenna device according to embodiments of the present disclosure may improve the radiation performance of an RF signal by reducing interference between antennas formed on a single substrate.

Conventional devices and methods for transmitting signals of different frequency bands involve providing different antennas, respectively corresponding to the different frequency bands, on a common substrate (e.g., on a single substrate) in order to reduce the physical dimensions of the devices. Radiation performance of one or more of the antennas (e.g., an antenna used for radar) suffers excessive deterioration from this arrangement due to surface waves generated by another of the antennas (e.g., a mmWave antenna).

However, according to embodiments, improved devices and methods are provided for transmitting signals of different frequency bands. For example, the improved devices and methods involve applying one or more shield structures (e.g., cavity-back structures) to one or more of different antennas (respectively corresponding to the different frequency bands). Accordingly, the improved devices and methods are able to provide the different antennas on a common substrate (e.g., on a single substrate) while minimizing (or reducing) surface waves between the different antennas (e.g., from a mmWave antenna). Therefore, the improved devices and methods overcome the deficiencies of the conventional devices and methods to at least improve radiation performance of the antenna(s) (e.g., an antenna used for radar) while reducing the physical dimensions of the devices.

According to embodiments, operations described herein as being performed by the antenna device 100, the RFFE 120, the RFIC 130, the PMIC 150, the processor 110, the antenna device 100A, the IFIC, the antenna device 100B, the antenna device 100C, the antenna device 100D, the wireless communication device 1200, the communication processor 910, the power modulator 300, the duplexer 920, the power amplifier PA, the digital transmission processor 810, the digital reception processor 820, each of the digital/analog converters DAC1 and DAC2, the analog/digital converter (ADC), the transmitter circuit TXC, the receiver circuit RXC, the local oscillator LO, the first analog baseband filter ABF1, the first mixer MX1, the amplifier 131, the second analog baseband filter ABF2, the second mixer MX2, the low-noise amplifier 132, the IoT device 1300, the communication interface 1320, the input/output (I/O) unit 1350, the sensor 1360, the processor 1310, the mobile terminal 1400, the processor 1401, the RF module 1700, the CPU 1410, the PMU 1430, the memory interface (I/F) 1440, the display controller (DCON) 1450, and/or the modem 1460 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 1330, the memory 1500, the RAM 1420, etc.). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The term “outside” refers to a region that is beyond the outermost confines of a physical object. The term “inside’ indicates that at least a portion of a region is partially contained within a boundary formed by the object. The term “substantially’ is defined to be essentially conforming to the particular dimension, shape or other word that substantially modifies, such that the component need not be exact. For example, Substantially cylindrical means that the object resembles a cylinder, but may have one or more deviations from a true cylinder.

Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

It will be understood that when an element is referred to as being “connected” or “coupled” to another element, it may be directly connected or coupled to the other element or intervening elements may be present.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Embodiments are described herein with reference to cross-sectional illustrations that are schematic illustrations of idealized examples. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

In addition to the above-described examples, the present disclosure may include simple design changes or easily changeable examples. In addition, the present disclosure may include techniques that may easily modify and implement embodiments. Therefore, the scope of the present disclosure should not be limited to the above-described examples, but should be defined by the claims described below as well as the claims and equivalents.

What is claimed is:

1. An antenna device comprising:
a printed circuit board;
a first antenna on a first surface of the printed circuit board, the first antenna including a first sensing antenna and a second sensing antenna;
a second antenna on the first surface, the second antenna including a plurality of antenna elements;
a first sensing shield structure forming a first groove, the first sensing antenna being within the first groove; and
processing circuitry electrically connected to the first antenna and the second antenna, the processing circuitry being configured to,
transmit a first signal of a first frequency band by supplying power to the first sensing antenna and the second sensing antenna, and
transmit a second signal of a second frequency band by supplying power to the plurality of antenna elements, the second frequency band being different from the first frequency band.

2. The antenna device of claim 1, wherein the first sensing shield structure includes:
a plurality of conductive layers substantially parallel to the first surface; and
a plurality of metal vias between the plurality of conductive layers.

3. The antenna device of claim 1, further comprising:
a first coupling element spaced apart from the first sensing antenna within the first groove,
wherein the processing circuitry is configured to supply power to the first sensing antenna through a coupling feed by supplying power to the first coupling element through a first feed path penetrating the first sensing shield structure.

4. The antenna device of claim 1, further comprising:
a first antenna shield structure forming a first antenna groove, a first antenna element among the plurality of antenna elements being within the first antenna groove,
wherein the processing circuitry is configured to supply power to the first antenna element through a second feed path penetrating the first antenna shield structure.

5. The antenna device of claim 4, further comprising:
a first antenna coupling element within the first antenna groove, the first antenna coupling element being connected to the second feed path,
wherein the processing circuitry is configured to supply power to the first antenna element through a coupling feed by supplying power to the first antenna coupling element through the second feed path.

6. The antenna device of claim 2, wherein at least a portion of the first sensing shield structure forms a portion of the first surface, the at least the portion of the first sensing shield structure being between the first sensing antenna and at least one of the plurality of antenna elements.

7. The antenna device of claim 1, wherein the plurality of antenna elements are spaced apart with a constant interval, the plurality of antenna elements being between the first sensing antenna and the second sensing antenna.

8. The antenna device of claim 1, wherein the first sensing antenna is between two adjacent antenna elements among the plurality of antenna elements.

9. The antenna device of claim 1, wherein the processing circuitry is configured to:
obtain distance information between an external object and the antenna device based on the first signal transmitted and received through the first antenna; and
transmit the second signal through the second antenna with a first transmission power in response to determining the external object is within a first distance from the antenna device based on the distance information, the first transmission power being less than or equal to a first maximum power set for the first distance.

10. The antenna device of claim 1, further comprising:
a radio frequency integrated circuit (RFIC) and a power management integrated circuit (PMIC) on a second surface of the printed circuit board, the second surface being parallel to the first surface,
wherein
the RFIC is electrically connected to the first antenna and the second antenna, and
the PMIC is electrically connected to the processing circuitry.

11. An antenna device comprising:
a printed circuit board;
a first antenna on a first surface of the printed circuit board, the first antenna including a first sensing antenna and a second sensing antenna;
a second antenna on the first surface, the second antenna including a plurality of antenna elements, and the second antenna being between the first sensing antenna and the second sensing antenna;
a first sensing shield structure forming a first groove, the first sensing antenna being within the first groove, and the first sensing shield structure forming an opening in the first surface; and
processing circuitry electrically connected to the first antenna and the second antenna, the processing circuitry being configured to transmit signals of different frequency bands by supplying power to each of the first antenna and the second antenna.

12. The antenna device of claim 11, wherein the processing circuitry is configured to:
transmit a first signal of a first frequency band to an external object using the first sensing antenna;
receive a reflected signal through the second sensing antenna, the reflected signal corresponding to the first signal transmitted from the first sensing antenna reflected by the external object; and
obtain distance information between the antenna device and the external object based on the reflected signal.

13. The antenna device of claim 12, wherein the processing circuitry is configured to transmit a second signal of a second frequency band through the second antenna with a first transmission power in response to determining the external object is within a first distance from the antenna device based on the distance information, the first transmission power being less than or equal to a first maximum power set for the first distance.

14. The antenna device of claim 11, wherein the first sensing shield structure includes:
a plurality of conductive layers substantially parallel to the first surface; and
a plurality of metal vias between the plurality of conductive layers.

15. The antenna device of claim 11, further comprising:
a first coupling element spaced apart from the first sensing antenna within the first groove,
wherein the processing circuitry is configured to supply power to the first sensing antenna through a coupling feed by supplying power to the first coupling element through a first feed path penetrating the first sensing shield structure.

16. The antenna device of claim 11, further comprising:
a first antenna shield structure forming a first antenna groove, a first antenna element among the plurality of antenna elements being within the first antenna groove,
wherein the processing circuitry is configured to supply power to the first antenna element through a second feed path penetrating the first antenna shield structure.

17. The antenna device of claim 11, wherein at least a portion of the first sensing shield structure is between the first sensing antenna and at least one of the plurality of antenna elements.

18. The antenna device of claim 11, further comprising:
a second sensing shield structure forms a second groove, the second sensing antenna being within the second groove.

19. An antenna device comprising:
a printed circuit board;
a first antenna on a first surface of the printed circuit board, the first antenna including a first sensing antenna and a second sensing antenna;
a second antenna on the first surface, the second antenna including a plurality of antenna elements, and the plurality of antenna elements being between the first sensing antenna and the second sensing antenna;
a first sensing shield structure forming a first groove, the first sensing antenna being in the first groove, and the first sensing shield structure forming an opening in the first surface;
a radio frequency front end (RFFE) connected to the first antenna and the second antenna;
a radio frequency integrated circuit (RFIC) connected to the RFFE; and
processing circuitry electrically connected to the first antenna and the second antenna through the RFIC and the RFFE, the processing circuitry being configured to transmit signals of different frequency bands by supplying power to each of the first antenna and the second antenna.

20. The antenna device of claim 19, wherein at least a portion of the first sensing shield structure forms a portion of the first surface, the at least the portion of the first sensing shield structure being between the first sensing antenna and at least one of the plurality of antenna elements.
